(19) United States
(12) Patent Application Publication
(10) Pub. No.: US 2018/0252649 A1
(43) Pub. Date: Sep. 6, 2018

(54) METHOD AND APPARATUS FOR MEASURING RAMAN SPECTRUM

(71) Applicant: TimeGate Instruments Oy, Oulu (FI)

(72) Inventors: Antti Härkönen, Tampere (FI); Jari Nikkinen, Tampere (FI)

(21) Appl. No.: 15/903,088

(22) Filed: Feb. 23, 2018

(30) Foreign Application Priority Data
Feb. 24, 2017 (FI) 20175178

(51) Int. Cl. G01N 21/65

(52) U.S. Cl. CPC G01N 21/65; G01N 2201/06113; G01N 2021/655

(57) ABSTRACT

An apparatus (500) for Raman spectroscopy includes:
a laser unit (200) to form laser pulses (LB1),
a conversion unit (100) to form illuminating pulses (LB3) from optical energy of the laser pulses (LB1),
optics (LNS1) to gather scattered light (LB4) from a sample (MX) when the sample (MX) is illuminated with the illuminating pulses (LB3),
a spectral disperser (350) to spatially separate spectral components (LB4_{λ1}, LB4_{λ2}, LB4_{λk}, LB4_{λN}) of the scattered light (LB4),
a detector array (ARR1) to measure intensity of the separated spectral components (LB4_{λ1}, LB4_{λ2}, LB4_{λk}, LB4_{λN}),
   wherein the conversion unit (100) includes:
a first crystal (NLC1) to generate second light pulses (LB2) from the laser pulses (LB1) by second harmonic generation,
a second crystal (RaC1) to generate the illuminating pulses (LB3) from the second light pulses (LB2) by stimulated Raman scattering.

### FIELD

The aspects of the disclosed embodiments relate to a method and an apparatus for measuring a Raman spectrum.

### BACKGROUND

Raman spectroscopy may be used e.g. to identify a sample. A sample may emit light by Raman scattering and also by fluorescence when the sample is illuminated with laser light pulses. The fluorescence may disturb measurement of a Raman spectrum. Emission of light by fluorescence is typically a slow process when compared with emission of Raman scattered light. The contribution of fluorescence may be reduced by using time-gated detection. An integration time period of a detector may be synchronized with the timing of an illuminating laser light pulse.

### SUMMARY

Some versions may relate to a method for measuring Raman spectrum of a sample. Some versions may relate to an apparatus for measuring Raman spectrum of a sample.

According to an aspect, there is provided an apparatus (500), comprising:
a laser unit (200) to form laser pulses (LB1),
a conversion unit (100) to form illuminating pulses (LB3) from optical energy of the laser pulses (LB1),
optics (320) to gather scattered light (LB4) from a sample (MX) when the sample (MX) is illuminated with the illuminating pulses (LB3),
a spectral disperser (350) to spatially separate spectral components (LB4_{λ1}, LB4_{λ2}, LB4_{λk}, LB4_{λN}) of the scattered light (LB4),
a detector array (ARR1) to measure intensity of the separated spectral components (LB4_{λ1}, LB4_{λ2}, LB4_{λk}, LB4_{λN}),

wherein the conversion unit (100) comprises:
a first crystal (NLC1) to generate light pulses (LB2) by sum frequency generation, and
a second resonator crystal (RaC1) to generate light pulses (LB3) by stimulated Raman scattering.

According to an aspect, there is provided a method, comprising:
providing laser pulses (LB1),
forming illuminating light pulses (LB3) from optical energy of the laser pulses (LB1) by using a conversion unit (100),
illuminating a sample (MX) with the illuminating light pulses (LB3),
collecting scattered light (LB4) from the sample (MX) when the sample (MX) is illuminated with the illuminating pulses (LB3),
spatially separating spectral components (LB4_{λ1}, LB4_{λ2}, LB4_{λk}, LB4_{λN}) of the scattered light (LB4),
measuring the intensity of the separated spectral components (LB4_{λ1}, LB4_{λ2}, LB4_{λk}, LB4_{λN}) by using a detector array (ARR1),

wherein the conversion unit (100) comprises:
a first crystal (NLC1) to generate light pulses by sum frequency generation, and
a second resonator crystal (RaC1) to generate light pulses (LB3) by stimulated Raman scattering.

Illuminating light pulses suitable for the excitation of the Raman scattered radiation may be obtained from the laser light pulses by using the conversion unit. The apparatus may be arranged to measure Raman spectrum of a sample by using time resolved detection. Using the conversion unit together with the laser unit may facilitate detection of the Raman spectrum of the sample.

Practically all materials may emit light by Raman scattering when illuminated with light, e.g. when the material comprises molecules and/or a crystal structure which has vibrational energy levels. Some molecules may emit light by the fluorescence in addition to emitting light by the Raman scattering. For example, organic molecules may emit light by fluorescence and by Raman scattering when illuminated by light. For example, organic molecules containing conjugated aromatic rings may emit light by fluorescence and by Raman scattering. The fluorescence may disturb measurement of the Raman spectrum. Emission of light by fluorescence is typically a slow process when compared with emission of Raman scattered light. The relative contribution of fluorescence on a measured Raman spectrum may be reduced when the sample material is illuminated with shortened illuminating light pulses.

The relative contribution of fluorescence may be reduced e.g. when the sample material is illuminated with shortened illuminating light pulses, and light emitted from the sample is measured by time gated detection where Raman scattered light is detected during a short time period, and fluorescence light arriving at a later time is rejected or compensated.

Using the conversion unit together with the laser unit may help to suppress the effect of fluorescence on the measured Raman spectrum. Using the conversion unit together with the laser unit may provide more accurate compensation of an error caused by fluorescence.

The temporal width of the illuminating pulses formed by the conversion unit may be substantially smaller than the temporal width of laser pulses coupled into the conversion unit. The conversion unit may be arranged to generate harmonic light pulses from laser pulses e.g. by second harmonic generation. The conversion unit may comprise a Raman crystal to form the illuminating pulses from the harmonic light pulses by stimulated Raman scattering. The temporal width of the illuminating pulses may be smaller than the temporal width of harmonic pulses coupled into the Raman crystal. The temporal width of the illuminating pulses may be e.g. in the range of 25 to 50 ps in a situation where the temporal width of the harmonic pulses is substantially equal to 85 ps. The small temporal width of the illuminating pulses may facilitate measurement of Raman scattered light by time gated detection. The small temporal width of the illuminating pulses may facilitate suppression of fluorescence in the measurement of the Raman spectrum.

Time-gated detection may be used in combination with the excitation by the short illuminating light pulses. An integration time period of a detector may be synchronized with the timing of an illuminating light pulse.

The detection limit of Raman spectroscopy may be limited e.g. by shot noise, by the disturbing effect of fluorescence, and/or by the dark current of the detector. The detector of the measuring apparatus may comprise e.g. an array of single photon avalanche diodes (SPAD) for measuring the intensity of the Raman scattered radiation. The detector array of the apparatus may be arranged to measure the intensity of the Raman scattered radiation by using time gated detection where the integration time of the detector may be set with a temporal resolution which is e.g. shorter than or equal to 100 ps.

The wavelength of the illuminating pulses formed by the conversion unit may be close to or within a spectral sensitivity range of the detector array such that the wavelengths of Raman-scattered light emitted from the sample MX may substantially match with said spectral sensitivity range. The detector may be implemented on a silicon substrate. The detector array may comprise e.g. single photon avalanche diodes. The wavelength of the illuminating pulses may be in a spectral range where the spectral response of the detector array is higher than a predetermined limit. The wavelengths of Raman-scattered light emitted from the sample MX may be in a spectral range where the spectral response of the detector array is higher than a predetermined limit.

Illuminating a sample MX with illuminating light may cause emission of light by fluorescence. In particular, illuminating an organic and/or biological sample MX with illuminating light may cause emission of light by fluorescence. The fluorescence light emitted from a sample may disturb measurement of Raman scattered light obtained from said sample. The fluorescence quantum yield may be decreased by increasing the wavelength of the illuminating light. In other words, the fluorescence quantum yield may be decreased when the fluorescence is excited by illuminating light, which has a longer wavelength. If the wavelength of the illuminating light is longer than a predetermined limit, then the fluorescence quantum yield may become substantially equal to zero because the energy of the photons is lower than the minimum energy needed to excite the fluorescence.

The conversion unit may be arranged to provide illuminating light at the wavelength, which may suppress the intensity of fluorescence when compared with the Raman scattering.

The wavelength of illuminating pulses obtained from the Raman crystal may be longer than the wavelength of the harmonic pulses. Using the Raman crystal may reduce or eliminate the disturbing effect of the fluorescence. Using the conversion unit may help to reduce the effect of fluorescence e.g. when the sample contains biological and/or organic material.

### BRIEF DESCRIPTION OF THE DRAWINGS

In the following examples, several versions will be described in more detail with reference to the appended drawings, in which

FIG. 1a shows, by way of example, an apparatus for measuring a Raman spectrum,

FIG. 1b shows, by way of example, a confocal optical arrangement for illuminating a sample and for collecting light emitted from the sample,

FIG. 2a shows, by way of example, a spectrum of an illuminating light pulse,

FIG. 2b shows, by way of example, a spectrum of light scattered from a sample,

FIG. 2c shows, by way of example, temporal evolution of intensity of an illuminating light pulse, temporal evolution of intensity of scattered light, and temporal response function of a detector pixel,

FIG. 3a shows, by way of example, a pulse conversion unit,

FIG. 3b shows, by way of example, spectral reflectivity of the first reflector of the Raman resonator cavity, spectral reflectivity of the second reflector of the cavity, and spectrum of light coupled out of the cavity,

FIG. 3c shows, by way of example, spectral reflectivity of the first reflector of the Raman resonator cavity, spectral reflectivity of the second reflector of the cavity, and spectrum of light coupled out of the cavity,

FIG. 3d shows, by way of example, temporal shape of pump light pulse coupled into the Raman resonator cavity, temporal shape of 1st Stokes component coupled out of the cavity, and temporal shape of 2nd Stokes component coupled out of the cavity,

FIG. 3e shows, by way of example, forming a temporally narrow light pulse by using the pulse conversion unit,

FIG. 4a shows, by way of example, an amplified microchip laser,

FIG. 4b shows, by way of example, a microchip laser, which comprises a hybrid reflector,

FIG. 5a shows, by way of example, a laser unit, which comprises a distributed feedback laser, and an optical amplifier,

FIG. 5b shows, by way of example, a laser unit, which comprises a distributed feedback laser, an optical modulator, and an optical amplifier,

FIG. 5c shows, by way of example, a laser unit, which comprises a distributed Bragg reflector laser, and an optical amplifier,

FIG. 5d shows, by way of example, a laser unit, which comprises a distributed Bragg reflector laser, an optical modulator, and an optical amplifier,

FIG. 5e shows, by way of example, a temporal shape of a laser pulse generated by using a microchip laser, and a temporal shape of a laser pulse generated by using a DFB or DBR laser,

FIG. 6 shows, by way of example, a pulse conversion unit,

FIG. 7a shows, by way of example, in a cross sectional view, a detector pixel of a detector array, and

FIG. 7b shows, by way of example, a detector array comprising an array of detector pixels.

### DETAILED DESCRIPTION

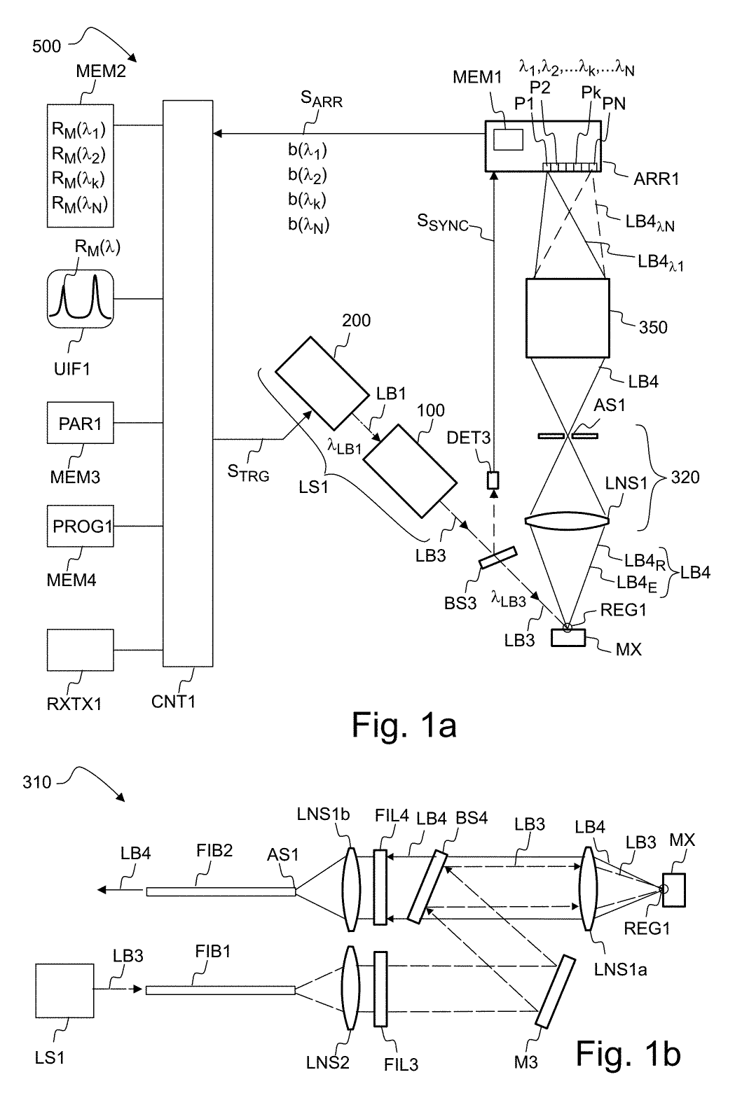

Referring to FIG. 1a, the measuring apparatus 500 may comprise an illuminating light source LS1 to provide an illuminating light pulses LB3. The measuring apparatus 500 may be arranged to illuminate a sample region REG1 with the light pulses LB3. The illuminating light source LS1 may comprise a laser unit 200 and a conversion unit 100 for forming the illuminating light pulses LB3. The light pulses LB3 may also be called e.g. as excitation light pulses.

The sample region REG1 may also be called e.g. as a sample volume or as a region of interest (ROI). At least a part of a sample MX may be positioned in the sample region REG1. The illuminating light pulses LB3 may be arranged to illuminate a sample MX, so as to cause inelastic scattering of photons from the sample MX. In particular, the illuminating light pulses LB3 may excite Raman scattering from the sample MX. The sample MX may comprise e.g. inorganic material. The sample MX may comprise e.g. organic material and/or biological material. The sample MX may comprise e.g. aromatic compounds, which may emit light by Raman scattering and by fluorescence. The sample MX may comprise e.g. gas, solid and/or liquid. The sample MX may comprise e.g. a heterogeneous mixture. The sample MX may comprise e.g. a heterogeneous mixture, which comprises particles suspended in a liquid or suspended in a gas. The particles may be e.g. solid particles, liquid particles and/or biological cells. The sample MX may be supported e.g. on a holder. The sample MX may be contained e.g. in a sample cell.

Sample material MX located in the sample region REG1 may provide scattered light LB4 when illuminated by an illuminating light pulse LB3. The scattered light LB4 may include Raman scattered light LB4_{R} and/or elastically scattered light LB4_{E}. The elastically scattered light LB4_{E} may include Rayleigh-scattered light from a homogeneous substance. The elastically scattered light LB4_{E} may include Mie-scattered light from particles of the sample MX. The elastically scattered light LB4_{E} may include Rayleigh-scattered light from a suspending medium and/or Mie-scattered light from one or more particles. The sample material MX may provide elastically scattered light LB4_{E} when illuminated by an illuminating light pulse LB3, and the material may provide Raman scattered light LB4_{R} when illuminated by the illuminating light pulse LB3. The wavelength of the elastically scattered light may be equal to the wavelength λ_{LB3} of the illuminating light pulses LB3.

The light source LS1 may comprise a laser unit 200 to provide first light pulses LB1, and a pulse conversion unit 100 to provide illuminating light pulses LB3. The conversion unit 100 may be arranged to generate the illuminating light pulses LB3 by using optical energy of the first light pulses LB1 such that the wavelength λ_{LB3} of the illuminating light pulses LB3 is e.g. in the range of 0.53 to 0.64 times the wavelength λ_{LB1} of the first light pulses LB1. For example, the wavelength λ_{LB3} of the illuminating light pulses LB3 may be 573 nm, 620 nm or 676 nm in a situation where the wavelength λ_{LB1} of the first light pulses LB1 is 1064 nm. Having the wavelength λ_{LB3} at said spectral range may reduce or eliminate the contribution of fluorescence.

Temporal width of the illuminating light pulses LB3 may also be substantially shorter than the temporal width of the first light pulses LB1, so as to allow effective compensation of fluorescence. The narrow temporal width may facilitate time gated detection.

The measuring apparatus 500 may comprise light gathering optics 320 to collect scattered light LB4 from the sample region REG1 to a spectrometer. The spectrometer may comprise a spectral disperser 350 and a detector array ARR1. The light gathering optics 320 may also at least partly define the spatial position of the sample region REG1. The light gathering optics 320 may comprise e.g. an aperture AS1 for defining the spatial position of the sample region REG1. The aperture AS1 may be e.g. pinhole, silt, or an end of an optical waveguide. The aperture AS1 may also be called e.g. as a field stop. The light gathering optics 320 may comprise e.g. one or more lenses and the aperture AS1. The aperture AS1 may define the boundary of the sample region REG1 such that light scattered from material outside the sample region REG1 is not effectively coupled via the disperser 350 to the detector array ARR1. The apparatus 500 may be arranged to deliver illuminating light LB3 to the sample region REG1 such that the intensity of illuminating light LB3 outside the sample region REG1 is substantially lower than the intensity of illuminating light LB3 inside the sample region REG1.

The apparatus 500 may optionally comprise an optical fiber for guiding the scattered light LB4 from the aperture AS1 to the disperser 350. An end of the optical fiber may be arranged to operate as the aperture AS1 (FIG. 1b).

The apparatus 500 may optionally comprise an optical fiber for guiding illuminating light pulses LB3 from the light source LS1 to the sample region REG1. The optical fiber may have a large mode area in order to reduce temporal and spectral broadening of a transmitted light pulse LB3.

The detector array ARR1 may comprise a plurality of detector pixels to detect light at a plurality of different spectral bands. N may denote the number of the spectral bands. The scattered light LB4 may be gathered by optics 320, and different spectral components LB4₁, LB4₂, . . . , LB4ₖ, . . . LB4_{N} of the scattered light LB4 may be spatially separated from each other by using a spectral disperser 350. The optics 320 may comprise e.g. one or more lenses, mirrors and/or prisms and/or filters. In particular, the optics 320 may comprise one or more lenses LNS1 for gathering scattered light LB4 from the sample volume and for focusing the gathered light via an aperture stop AS1 to the spectral disperser 350.

The spectral disperser 350 may decompose the gathered light LB4 e.g. into spectral components LB4_{λ1}, LB4_{λ2}, LB4_{λk}, LB4_{λN}, and the disperser 200 may direct the spectral components LB4_{λ1}, LB4_{λ2}, LB4_{λk}, LB4_{λN} to different spatial positions of the detector array ARR1. The disperser 350 may comprise e.g. one or more diffraction gratings and/or prisms. The detector ARR1 may comprise an array of detector pixels P1, P2, Pk, PN. Each detector pixel P1, P2, Pk, PN of the detector array ARR1 may be arranged to measure the spectral intensity of light LB4 at a different wavelength λ₁, λ₂, λₖ, λ_{N}. For example, the component LB4_{λ1} may be directed to the detector pixel P1, the component LB4_{λ2} may be directed to the detector pixel P2, the component LB4_{λk} may be directed to the detector pixel Pk, and the component LB4_{λN} may be directed to the detector pixel PN. Each detector pixel P1, P2, Pk, PN of the detector array 350 may be arranged to measure the intensity of light LB4 at a different wavelength band, wherein the wavelengths λ₁, λ₂, λₖ, λ_{N} may denote the centers of said wavelength bands, respectively.

The intensities of the spectral components LB4_{λ}, LB4_{λ2}, . . . , LB4_{λk}, . . . LB4_{λN} may be measured by the detector array ARR1. The detector array ARR1 may comprise an array of detector pixels P1, P2, . . . Pk, . . . PN. The detector ARR1 may provide a plurality of measured values b(λ₁), b(λ₂), . . . b(λₖ), . . . b(λ_{N}) indicative of the measured intensities of the spectral components LB4₁, LB4₂, . . . , LB4ₖ, . . . LB4_{N}, respectively. Each measured value b(λ₁), b(λ₂), . . . b(λₖ), . . . b(λ_{N}) may be indicative of spectral intensity of the scattered light LB4 at a different wavelength λ₁, λ₂, . . . λₖ, . . . λ_{M}. The detector ARR1 may optionally comprise a memory MEM1 for storing the measured values b(λ₁), b(λ₂), . . . b(λₖ), . . . b(λ_{N}). The memory MEM1 may be called e.g. as a buffer memory. The measured values b(λ₁), b(λ₂), . . . b(λₖ), . . . b(λ_{N}) may be communicated from the detector ARR1 e.g. as a signal S_{ARR}.

In particular, the detector array ARR1 may comprise e.g. an array of single photon avalanche diodes (SPAD). The method may comprise measuring the spectral intensity distribution I(λ) of Raman scattered light pulses LB4_{R} by using an array ARR1 of single photon avalanche photodiodes (SPAD). Using the SPAD detector may allow e.g. reducing the noise level of the measured results.

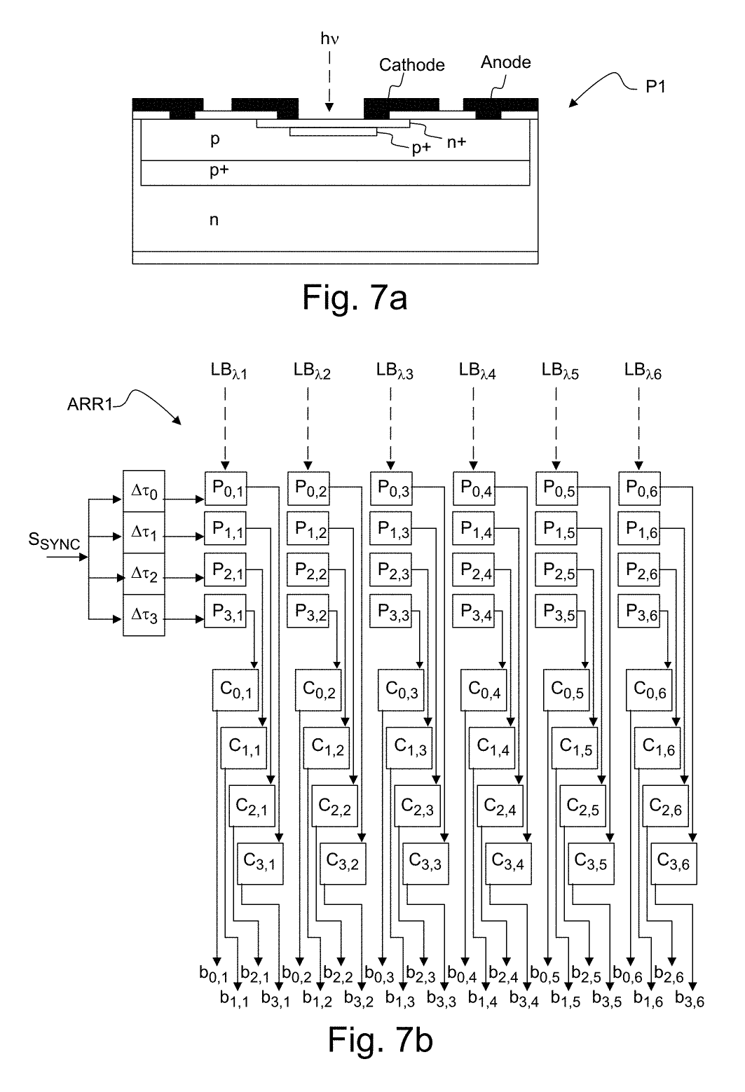

The timing of operation of the detector array ARR1 may be controlled based on a timing signal S_{SYNC}. The operation of the detector array ARR1 may be enabled and disabled based on the signal S_{SYNC}. In particular, a SPAD detector ARR1 may comprise a set of counters (See FIG. 7b). The operation of said set of counters may be enabled and disabled based on the timing signal S_{SYNC}. The timing signal S_{SYNC} may be formed e.g. by using a beam splitter BS3 and an auxiliary detector DET3.

The detector array ARR1 may provide a detector signal S_{ARR}. The signal S_{ARR} may comprise a plurality of measured Raman signal values b(λ₁), b(λ₂), b(λₖ), b(λ_{N}). Each Raman signal value b(λ₁), b(λ₂), b(λₖ), b(λ_{N}) may indicate the spectral intensity of Raman scattered light at a spectral position λ₁, λ₂, λₖ, λ_{M}.

The laser unit 200 may be arranged to provide laser light pulses LB1. The laser light pulses LB1 may be coupled into the conversion unit 100 in order to form the illuminating pulses LB3.

The laser unit 200 may comprise e.g. a passively Q-switched laser.

The laser unit 200 may comprise e.g. a Q-switched Nd:YVO₄ laser (neodymium-doped yttrium orthovanadate) or a Q-switched Nd:YAG laser (neodymium-doped yttrium aluminium garnet). Using the Nd:YVO₄ may facilitated providing short laser pulses. The wavelength of the laser light pulses LB1 may be e.g. 1064 nm.

The laser unit 200 may comprise e.g. a microchip laser. The microchip laser may comprise a laser crystal (or glass), wherein the reflectors of the laser cavity may be directly implemented on the laser crystal (or glass). The microchip laser may comprise a semiconductor saturable absorber mirror (SESAM). The laser crystal (glass) may be optically pumped e.g. by using one or more laser diodes.

The term microchip laser may mean an optically pumped solid-state laser with a monolithic construction, wherein at least one reflector of the laser resonator of said laser has been implemented on the lasing solid state medium of said laser. In particular, at least one reflector of the microchip laser may be implemented on the lasing crystal of the microchip laser.

The laser unit 200 may comprise e.g. an optical amplifier, which comprises a light-amplifying optical crystal or glass medium. The laser unit 200 may comprise e.g. an optical amplifier, which comprises light-amplifying optical bulk crystal. The laser unit 200 may comprise e.g. an optical amplifier, which comprises light-amplifying optical fiber.

The repetition rate of the laser pulses may be e.g. in the range of 1 Hz to 10 MHz. The repetition rate of the laser pulses may be e.g. in the range of 10 kHz to 1 MHz. The laser unit 200 may be arranged to generate single pulses.

The laser unit 200 may be arranged to generate the single pulses according to a trigger signal S_{TRG}, which may be provided e.g. by the control unit CNT1, by the detector ARR1, by a clock, or by an auxiliary trigger device. The control unit CNT1, the detector ARR1, a clock, or an auxiliary trigger device may be arranged to send a trigger signal S_{TRG} to the laser unit 200, so as to trigger generating a laser pulse on demand. The laser unit 200 may be arranged to generate a sequence of pulses according to the trigger signal S_{TRG}.

The operating lifetime of the laser unit 200 may depend on the maximum intensity of the laser pulses and also on the temporal width of the laser pulses. Generating of short intense laser pulses may be associated with a risk of damaging a critical component of the laser unit. A laser unit may be arranged to provide laser pulses such that the temporal width of the laser pulses is greater than a predetermined limit in a situation where the maximum intensity of the laser pulses is in a predetermined range, so as to provide a certain minimum operating lifetime for the laser unit 200.

The temporal width Δt_{FWHM,LB1} of the laser light pulses LB1 may be e.g. in the range of 50 ps to 100 ps.

The temporal width Δt_{FWHM,LB1} of the laser light pulses LB1 may be e.g. longer than or equal to 50 ps e.g. in order to reduce risk of damaging the microchip laser. The temporal width Δt_{FWHM,LB1} of the laser light pulses LB1 may be longer than or equal to 50 ps in order to reduce risk of damaging the saturable absorber of the microchip laser. The temporal width Δt_{FWHM,LB1} of the laser light pulses LB1 may be longer than or equal to 50 ps in order to allow using a high repetition rate of the laser light pulses LB1.

The apparatus 500 may comprise a synchronization detector DET3 for controlling timing of operation of the detector array ARR1. The apparatus 500 may comprise e.g. a beam splitter BS3 to guide a part of the light of the pulses LB3 to the detector DET3. The detector DET3 may generate a synchronization signal S_{SYNC} for the controlling timing of operation of the detector array ARR1. The signal S_{SYNC} may also be called e.g. as a timing signal. The signal S_{SYNC} may comprise a timing pulse. The signal S_{SYNC} may be called as a timing pulse.

The apparatus 500 may comprise a data processing unit CNT1 for processing the data b(λ₁), b(λ₂), . . . b(λₖ), . . . b(λ_{N}) obtained from the detector array ARR1. The apparatus 500 may comprise a memory MEM2 for storing output values R_{M}(λ₁), R_{M}(λ₂), . . . R_{M}(λₖ), . . . R_{M}(λ_{N}) determined from the measured values. The output values R_{M}(λ₁), R_{M}(λ₂), . . . R_{M}(λₖ), . . . R_{M}(λ_{N}) may specify a measured Raman spectrum R_{M}(λ) of the sample MX. The data processing unit CNT1 may be configured to determine a measured Raman spectrum R_{M}(λ) from measured values b(λ₁), b(λ₂), . . . b(λₖ), . . . b(λ_{N}) obtained from the detector array ARR1. The measured spectrum R_{M}(λ) may represent a Raman spectrum where the contribution of fluorescence has been compensated or eliminated.

The apparatus 500 may comprise a control unit CNT1 for controlling operation of the apparatus 500 and/or for processing the data b(λ₁), b(λ₂), . . . b(λₖ), . . . b(λ_{N}) obtained from the detector array ARR1. The apparatus 500 may comprise a memory MEM4 for storing computer program PROG1. When executed by one or more data processors CNT1, the computer program PROG1 may cause the apparatus 500 e.g. to measure Raman signal values and/or to process Raman signal values.

The apparatus 500 may comprise a memory MEM3 for storing operating parameters PAR1. The operating parameters PAR1 may specify e.g. the duration(s) of integration time period(s) for the detector pixels.

The apparatus 500 may comprise a user interface UIF1 for providing information to a user and/or for receiving user input from the user. The user interface UIF1 may comprise e.g. a display, touch screen and/or a keypad. For example, the user interface UIF1 may be configured to graphically display a measured Raman spectrum R_{M}(λ). For example, the user interface UIF1 may be configured to display a graph, which represents a measured Raman spectrum R_{M}(λ).

The apparatus 500 may comprise communication unit RXTX1 for sending and/or receiving data. The communication unit RXTX1 may be arranged to communicate e.g. with a local area network, with the Internet, and/or with mobile communications network. The apparatus 500 may also be arranged perform data processing in a distributed manner, e.g. by using an Internet server.

Referring to FIG. 1b, the sample MX may be illuminated, and light emitted from the sample MX may be gathered e.g. by using a confocal optical unit 310. The apparatus 500 may comprise an optical fiber FIB1 for guiding illuminating light LB3 from the light source LS1 to the optical unit 310. The illuminating light LB3 may be guided from the fiber FIB1 to the sample MX e.g. via a collimating lens LNS2, via a reflector M3, via a spectrally selective beam combiner BS4, and via a focusing lens LNS1a. The emitted light LB4 may be guided from the sample MX to the spectrometer e.g. via the collimating lens LNS1a, via the spectrally selective beam combiner BS4, via a focusing lens LNS1b, and via an optical fiber FIB2. The unit 310 may optionally comprise one or more filters FIL3, FIL4 for rejecting spectral components, which are outside a desired spectral range. The component LNS1a may also be e.g. a microscope objective.

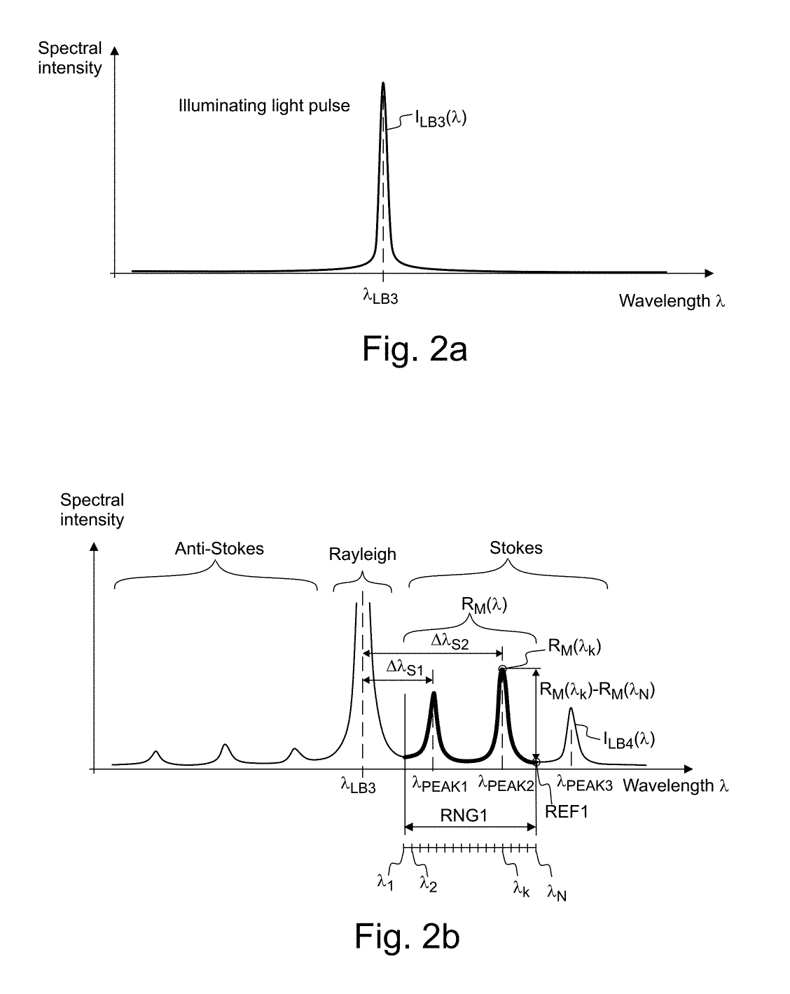

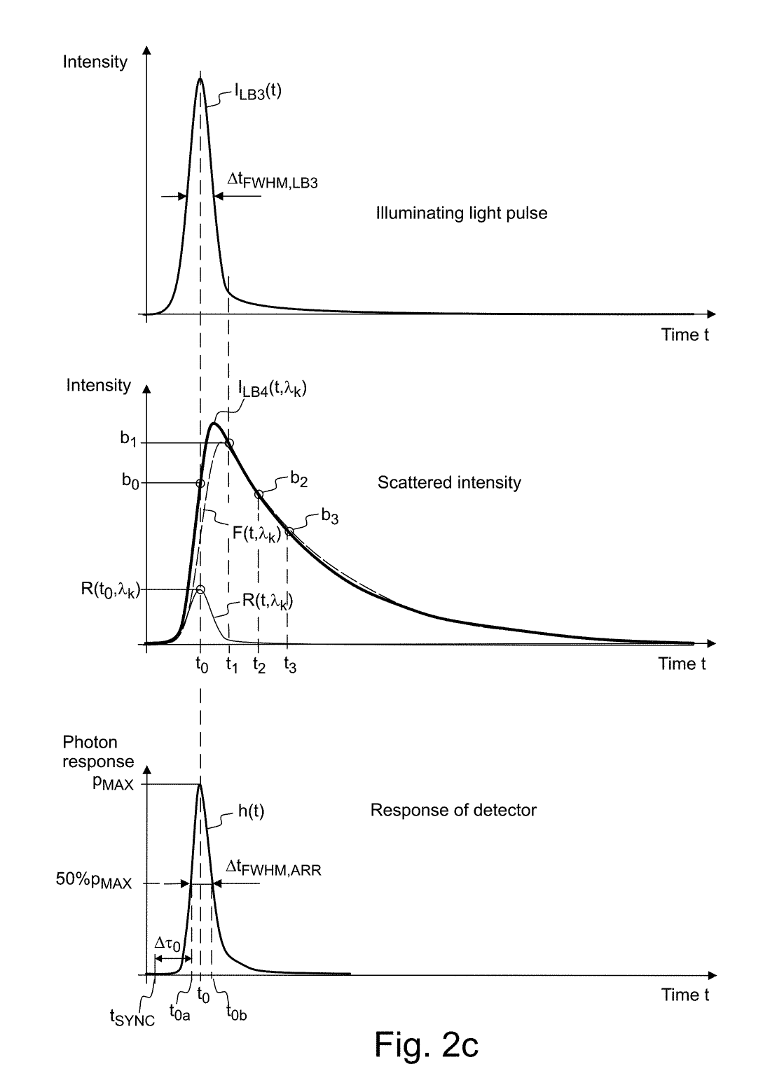

Referring to FIG. 2a, the conversion unit 100 may form illuminating light pulses LB3, which have a spectral intensity distribution I_{LB3}(λ). In particular, an illuminating light pulse LB3 generated at a time t₀ may have a spectral peak, which is located at the wavelength λ_{LB3}.

FIG. 2b shows, by way of example, the spectral intensity distribution I_{LB4}(λ) of emitted light LB4 obtained from the sample MX at the time t₀, in a situation where the sample MX is illuminated with the illuminating light pulse LB3 of FIG. 2a. The scattered light LB4 may comprise inelastically scattered light and elastically scattered light. The inelastically scattered light may comprise Raman scattered light and Rayleigh scattered light. Illuminating a sample MX with the illuminating pulses LB3 may cause emission of Rayleigh scattered light in addition to emission of the Raman scattered light. The inelastically scattered light may also comprise fluorescence light in addition to the Raman scattered light. Light emitted from the sample MX may comprise light emitted by fluorescence, in addition to light emitted by Raman and Rayleigh scattering. FIG. 2b shows only spectral components caused by Raman and Rayleigh scattering. Spectral components caused by fluorescence have been omitted from the spectrum shown FIG. 2b.

The sample MX may comprise molecules, which have vibrational and/or rotational energy states. The sample MX may have a crystal structure, which has vibrational energy states. The Raman scattered light may comprise Stokes-scattered light and anti-Stokes scattered light.

Stokes Raman scattering is an inelastic scattering process where a photon of illuminating light LB3 may lose energy into a change of vibrational and/or rotational state of the sample MX, i.e. the difference (E_{λLB3}-E_{λLB4}) between the energy E_{λLB3} of the incident photon LB3 and the energy E_{λLB4} of the corresponding scattered photon LB4 is positive. The photon of illuminating light LB3 may lose energy into a change of vibrational state and into a change rotational state of the sample MX.

Anti-Stokes Raman scattering is an inelastic scattering process where a scattered photon LB4 may gain energy from a change of vibrational state of the sample MX, i.e. the difference (E_{λLB3}-E_{λLB4}) between the energy E_{λLB3} of the incident photon LB3 and the energy E_{λLB4} of the corresponding scattered photon LB4 is negative. The photon of scattered light LB4 may gain energy from a change of vibrational state and from a change rotational state of the sample MX.

A Raman spectrum of the sample MX may be used e.g. for providing information about the molecular composition of the sample MX. The information may be used e.g. for qualitative chemical analysis of the sample MX, for quantitative chemical analysis of the sample MX, and/or for analyzing a crystal structure of the sample MX. An industrial process may be controlled based on the information. The information may be used e.g. for a forensic purpose, e.g. may be used as evidence in court.

The sample MX may comprise e.g. organic and/or inorganic molecules. The sample MX may contain e.g. molecules of biological material. The sample MX may comprise e.g. a single crystal, polycrystalline material or amorphous material.

The apparatus 500 may be arranged to determine a measured Raman spectrum R_{M}(λ). The measured Raman spectrum R_{M}(λ) may be determined from measured signal values obtained from the detector array ARR1. The measured spectrum R_{M}(λ) may comprise a plurality of Raman signal values R_{M}(λ₁), R_{M}(λₖ), R_{M}(λₖ₊₁), R_{M}(λ_{N}). The measured Raman spectrum R_{M}(λ) may be an estimate of an actual Raman spectrum emitted from the sample MX. The measured Raman spectrum R_{M}(λ) may cover e.g. a spectral range RNG1.

The Rayleigh-scattered light may have high intensity at the wavelength λ_{LB3} of the illuminating light pulse LB3.

The Raman-scattered light LB4 obtained from the sample may have one or more spectral peaks at wavelengths λ_{PEAK1}, λ_{PEAK2}, λ_{PEAK3}, which are different from the wavelength λ_{LB3} of the illuminating light pulse LB3. The measured Raman spectrum R_{M}(λ) may comprise e.g. one or more spectral peaks PEAK1, PEAK2. The measured Raman spectrum R_{M}(λ) may comprise e.g. a spectral peak PEAK2 at the wavelength λₖ. The Raman spectrum of the sample MX may comprise a reference point REF1 e.g. at the wavelength λ_{N}. The height R_{M}(λₖ)-R_{M}(λ_{N}) of the spectral peak PEAK2, when compared with the reference point REF1, may be used e.g. for estimating the chemical composition of the sample MX. A Raman spectrum measured by the apparatus 500 may be compared with reference data e.g. in order to identify a sample MX. A Raman spectrum measured by the apparatus 500 may be compared with reference data e.g. in order to determine chemical composition of the sample MX. The height and/or position of one or more spectral peaks of the measured spectrum R_{M}(λ) may be used for estimating a concentration of a substance in the sample MX. The measured spectrum R_{M}(λ) may be compared reference spectral data e.g. in order to identify a sample MX. A multivariate chemometric model may be used for qualitative and/or quantitative analysis.

The spectral disperser 350 and the detector array ARR1 may be arranged to measure spectral intensities in the spectral range RNG1. The spectral range RNG1 may cover one or more spectral features of light scattered from the sample MX, so as to measure a Raman spectrum of the sample MX. The spectral feature may be e.g. a peak or a dip of the spectrum.

FIG. 2c shows temporal evolution of laser beam intensity, temporal evolution of intensity of scattered light, and temporal response function of an individual detector pixel of the detector ARR1.

The uppermost curve of FIG. 2c shows by way of example, temporal evolution I_{LB3}(t) of the intensity of illuminating light LB3.

An individual illuminating light pulse LB3 may have a temporal width Δt_{FWHM,LB3}. The acronym FWHM may denote full width at half maximum. The temporal width Δt_{FWHM,LB3} of the pulse LB3 may be e.g. in the range of 20 ps to 50 ps.

The middle part of FIG. 2c shows temporal evolution of the spectral intensity R(t,λₖ) of Raman scattered light, temporal evolution of the spectral intensity F(t,λₖ) of fluorescence light, and temporal evolution of total spectral intensity I_{LB4}(t,λₖ). Illuminating the sample MX with the illuminating light pulse LB3 may cause emission of Raman scattered light and fluorescence light. Temporal evolution of the spectral intensity of the Raman scattered light at a given wavelength λₖ may be represented by the function R(t,λₖ). Temporal evolution of the spectral intensity of the fluorescence light at said wavelength λₖ may be represented by the function F(t,λₖ). To the first approximation, the total spectral intensity I_{LB4}(t,λₖ) may equal to the sum R(t,λₖ)+F(t,λₖ).

Referring to the lowermost curve of FIG. 2c, a detector pixel P1 of the detector ARR1 may be arranged to measure the total spectral intensity I_{LB4}(t,λₖ) at a wavelength λₖ during a short time integration time period specified by a timing t. The operation of the detector pixel P1 may be synchronized with the operation of the light source LS1 e.g. by using a synchronization signal S_{SYNC} obtained from the light source LS1, from an auxiliary detector DET3, or from the control unit CNT1. The apparatus may comprise a delay unit for controlling and/or adjusting timing of operation of the detector based on the signal S_{SYNC}.

A value b₀ may be measured e.g. during an integration time period, which comprises a time t₀. The apparatus 500 may be arranged to operate such that the time t₀ may substantially coincide with the time when the Raman scattered signal reaches a maximum value.

In an embodiment, the measured value b₀ may be directly used as an estimate R_{M}(t,λₖ) for the spectral intensity of the Raman scattered light at the wavelength λₖ.

In an embodiment, a value c₀·b₀ may be used as an estimate R_{M}(t,λₖ) for the spectral intensity of the Raman scattered light at the wavelength λₖ, wherein c₀ denotes a predetermined coefficient.

The detected intensity I_{LB4}(t,λₖ) of scattered light may comprise a contribution of fluorescence in addition to the contribution of the Raman scattered light and in addition to the contribution of other scattering mechanisms. The contribution of the fluorescence may be estimated e.g. from one or more measured intensity values b₁, b₂, b₃. The estimated contribution of the fluorescence may be subsequently eliminated from the measured intensity value b₀.

The apparatus 500 may be arranged to measure Raman spectrum of a sample by using time resolved detection. The apparatus 500 may be configured to measure Raman scattered intensity by time gated detection. The total intensity I_{LB4}(t,λ) measured by the detector array ARR1 may comprise the combined effect of Raman scattered light and fluorescence light. The apparatus 500 may be configured to measure a first value b₀ at a first time t₀ and to measure a second value b₁ at a second time t₁. The times t₀, t₁ may be selected e.g. such that the Raman-scattered intensity R(t,λ) reaches a peak value at the time t₀, and such that the Raman-scattered intensity R(t,λ) is e.g. smaller than 10% of the peak value at the time t₁.

The apparatus 500 may be configured to estimate the intensity F(t₀,λ) of fluorescence light at the time t₀ based on one or more values b₁, b₂, b₃ measured after said time t₀. The apparatus 500 may be configured to estimate the intensity F(t₀,λ) from one or more values b₂, b₃, b₄ e.g. by using a regression function. The apparatus 500 may be configured to estimate the intensity F(t₀,λ) from one or more values b₂, b₃, b₄ e.g. by using an extrapolation function. The apparatus 500 may be configured to calculate the spectral intensity R(t₀,λ) of Raman scattered light based on the value b₀ measured at the time t₀ and based on the estimated spectral intensity F(t₀,λ). The apparatus 500 may be configured to calculate the spectral intensity R(t₀,λ) of Raman scattered light e.g. by subtracting the estimated intensity value F(t₀,λ) from the value b₀.

For example, a value c₀·b₀-c₁·b₁ may be used as an estimate R_{M}(t,λₖ) for the spectral intensity of the Raman scattered light at the wavelength λₖ, wherein c₀ denotes a first predetermined coefficient, and c₁ denotes a first second predetermined coefficient. The coefficients c₀, c₁ may be determined e.g. by calibration tests and/or by simulation. For example, a value c₀·b₀-c₁·b₁-c₂·b₂-c₃·b₃ may be used as an estimate R_{M}(t,λₖ) for the spectral intensity of the Raman scattered light at the wavelength λₖ, wherein c₀, c₁, c₂, c₃, denote predetermined coefficients, which may be determined e.g. by calibration tests and/or by simulation. Determining an estimate R_{M}(t,λₖ) for the spectral intensity of the Raman scattered light at the wavelength λₖ may comprise calculating a linear combination of two or more measured values b₀, b₁, b₂, b₃.

The measured values b₀, b₁, b₂, b₃ obtained from the detector array ARR1 may correspond to a convolution of the total intensity I_{LB4}(t,λk) and a temporal response function h(t) of the detector array ARR1. The response function h(t) may be a response function of an individual detector pixel. Each measured value b₀, b₁, b₂, b₃ may be indicative of the total (spectral) intensity I_{LB4}(t,λₖ) during an integration time period at the specified spectral position λₖ. The integration time period for measuring a value b₀, b₁, b₂, or b₃ may be defined by the temporal width Δt_{FWHM,ARR} of a single detector pixel P1 of the detector array ARR1 and also by timing of operation of said detector pixel P1.

The accuracy of the time-gated measurement and estimation may be improved when the illuminating light pulse LB3 has a narrow temporal width Δt_{FWHM,LB3} and when the detector pixels P1 of the detector array ARR1 have a narrow temporal width Δt_{FWHM,ARR}.

The pulse conversion unit 100 of the apparatus 500 may be arranged to provide illuminating light pulses LB3, which have a narrow temporal width Δt_{FWHM,LB3}. The wavelength of the illuminating light pulses LB3 may be close to or within an optimum spectral sensitivity range of the detector ARR1.

The wavelength of the illuminating light pulses LB3 may be close to or within an optimum spectral sensitivity range of the detector ARR1 such that the wavelength of the Raman scattered light LB4_{R} emitted from the sample may substantially match with the spectral sensitivity range of a detector ARR1, which is implemented on a silicon substrate. The wavelength of the Raman scattered light LB4_{R} emitted from the sample may substantially match e.g. with the spectral sensitivity range of single photon avalanche diodes.

Furthermore, the wavelength of the illuminating light pulses LB3 may be selected such that the intensity of fluorescence emitted e.g. from an organic sample may be reduced. The wavelength of the illuminating light pulses LB3 may be e.g. in the range of 570 nm to 680 nm in order to suppress fluorescence and in order to match with the spectral sensitivity of the detector.

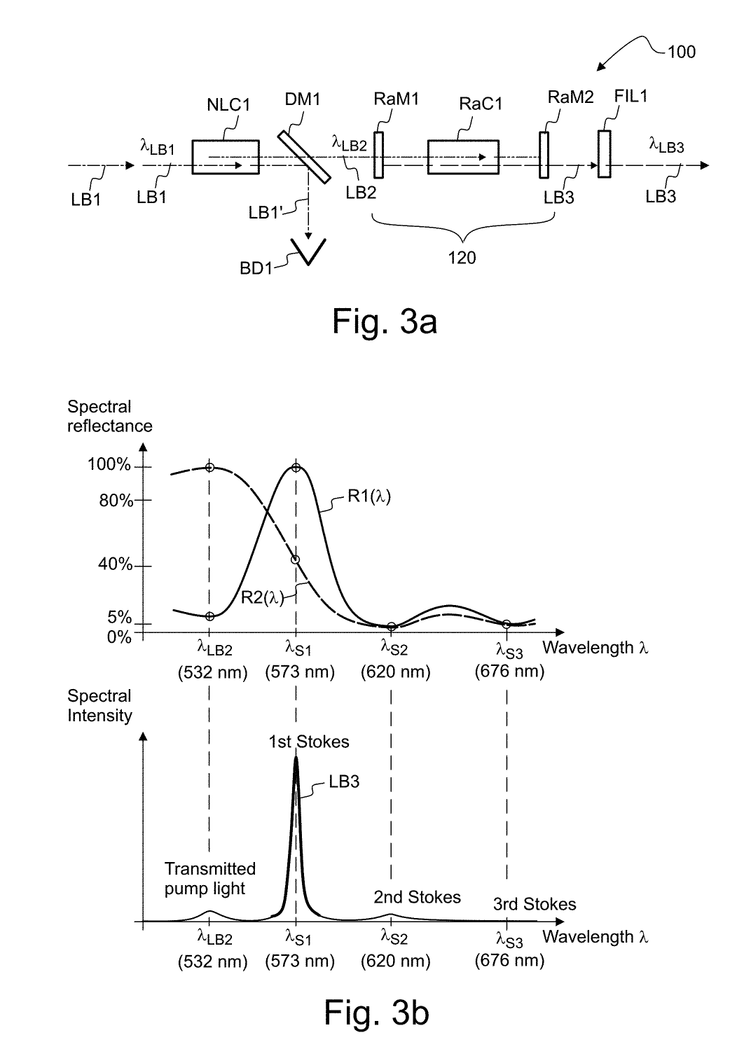

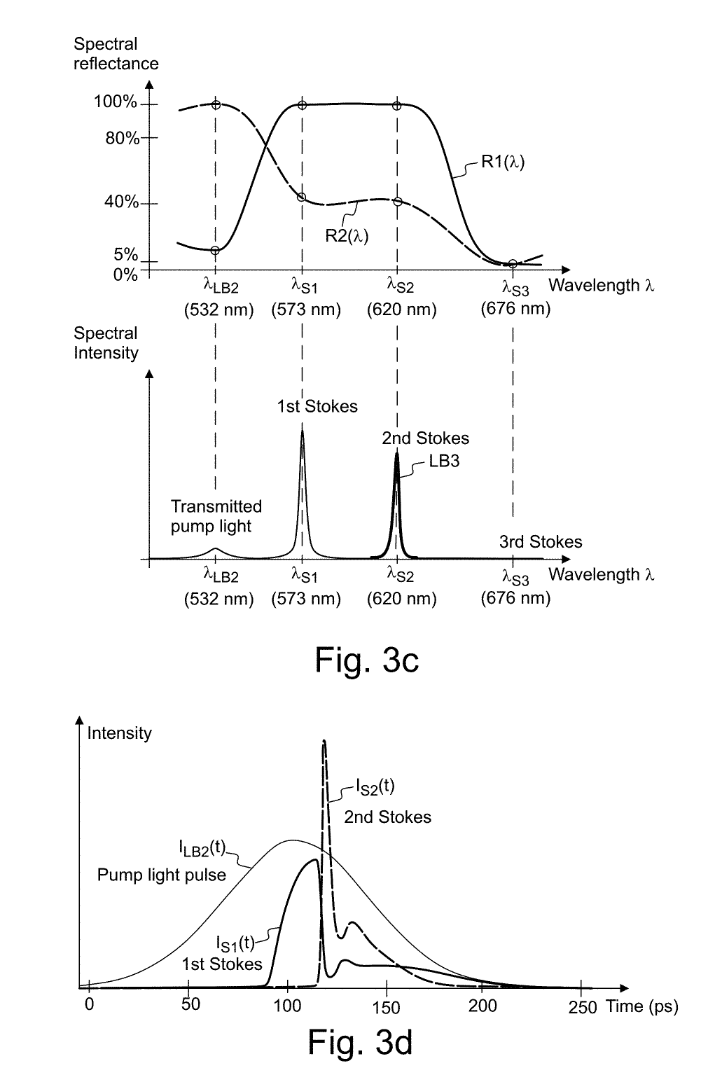

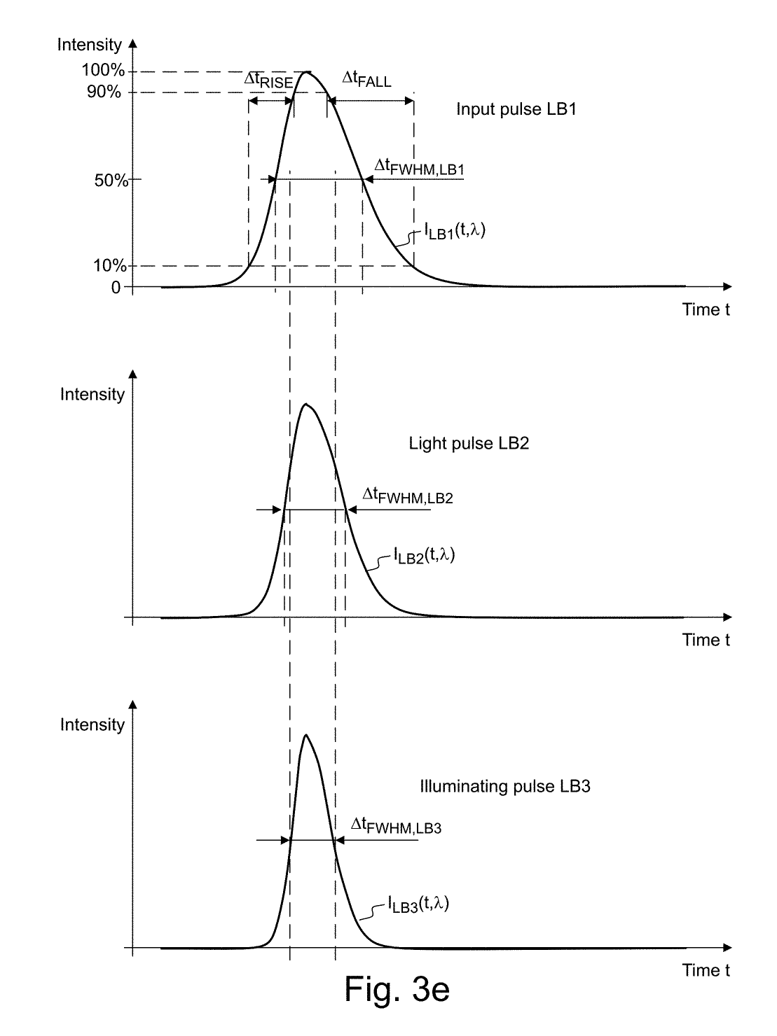

Referring to FIG. 3a, the measuring apparatus 500 may comprise a pulse conversion unit 100 to form light pulses LB3 from optical energy of input light pulses LB1. The pulse conversion unit 100 may comprise a frequency conversion crystal NLC1 and Raman crystal RaC1.

The frequency conversion crystal NLC1 may form light pulses LB2 from optical energy of the input light pulses LB1 by nonlinear frequency conversion. The frequency conversion crystal NLC1 may form light pulses LB2 from optical energy of the input light pulses LB1 by sum frequency generation. The frequency conversion crystal NLC1 may form light pulses LB2 from optical energy of the input light pulses LB1 by second harmonic generation.

The frequency conversion crystal NLC1 may form harmonic light pulses LB2 from optical energy of the input light pulses LB1. The optical frequency of the harmonic light pulses LB2 may be equal to an integer multiple of the optical frequency of the input light pulses LB1. The crystal NLC1 may form the harmonic light pulses LB2 from the input light pulses LB1 e.g. by second harmonic generation, by third harmonic generation, or by fourth harmonic generation. Second harmonic generation, third harmonic generation and fourth harmonic generation are special cases of sum harmonic generation.

In particular, the optical frequency of the harmonic light pulses LB2 may be substantially equal to two times the optical frequency of the input light pulses LB1. The wavelength of the harmonic light pulses LB2 may be substantially equal to 50% of the wavelength of the input light pulses LB1, respectively. Using the second harmonic generation together with the Raman crystal may provide light pulses, which are within an optimum wavelength range regarding suppression of fluorescence, regarding spectral range of the detector, and regarding conversion efficiency.

The crystal NLC1 may comprise or consist of e.g. Lithium Triborate (LBO), Lithium niobate (LN), Beta Barium Borate, Potassium Dideuterium Phosphate (KDP), or Potassium titanyl phosphate (KTP). The crystal NLC1 may be periodically poled in order to improve conversion efficiency. The crystal NLC1 may comprise e.g. periodically poled lithium niobate.

The Raman crystal RaC1 may form illuminating light pulses LB3 from optical energy of the harmonic light pulses LB2 by stimulated emission of Raman scattered photons. Simultaneous illumination of the Raman crystal RaC1 with a light pulse LB2 and with one or more photons at the wavelength λ_{LB3} may cause stimulated emission of Raman scattered photons from said crystal RaC1. The conversion unit 100 may comprise reflectors RaM1, RaM2 for reflecting a part of the photons of the light LB3 back to the Raman crystal RaC1. The stimulated emission may rapidly increase the number of photons emitted from the Raman crystal RaC1 at the wavelength λ_{LB3}.

The Raman crystal may be arranged to operate as a part of an optical resonator cavity, in order to feed a part of the light LB3 back to the crystal RaC1. The Raman crystal may be arranged to operate as a part of an optical resonator cavity, and the Raman crystal may also be called e.g. as a Raman resonator crystal.

The optical frequency of the light pulses LB3 may be different from the optical frequency of the light pulses LB2. In particular, the optical frequency of the light pulses LB3 may be substantially lower than the optical frequency of the light pulses LB2. The wavelength of the light pulses LB3 may be substantially longer than the wavelength of the light pulses LB2. The Raman crystal RaC1 may comprise e.g. diamond, boron doped diamond, barium nitrate, or potassium gadolinium tungstate (KGW).

The conversion unit 100 may comprise an optical resonator cavity 120 defined by reflectors RaM1, RaM2. The resonator cavity 120 may comprise the Raman crystal RaC1. In particular, the reflectors RaM1, RaM2 may be implemented on the crystal RaC1. The first reflector RaM1 may be arranged to transmit light of the harmonic pulses LB2 into the cavity 120. Harmonic pulses LB2 may be coupled from the frequency conversion crystal NLC1 into the Raman crystal RaC1 via the first reflector RaM1. A part of the light of the harmonic pulses LB2 may be subsequently transmitted through the Raman crystal RaC1 to the second reflector RaM2. The second reflector RaM2 may be arranged to reflect light of the harmonic pulses LB2 back into the Raman crystal RaC1. The Raman crystal RaC1 may form the illuminating pulses LB3 from optical energy of the harmonic pulses LB2 by stimulated Raman scattering.

The Raman crystal RaC1 may have a first reflector surface and a second reflector surface. The distance between the reflector surfaces, i.e. the length of the crystal RaC1 may be e.g. in the range of 0.1 mm to 5 mm. The first reflector surface may be substantially parallel with the second reflector surface. The first reflector RaM1 may be implemented on the first reflector surface and the second reflector RaM1 may be implemented on the second reflector surface. The first reflector surface and/or a second reflector surface may be substantially planar. The first reflector surface may be substantially parallel with the second reflector surface. The first reflector surface and/or a second reflector surface may also be convex in order to stabilize the cavity for TEM00 laser mode. The convex surfaces may improve the conversion efficiency of the resonator 120. The length of the crystal RaC1 and the length of the resonator cavity 120 may be selected according to a desired output pulse duration, according to a desired round trip time of the light in the cavity, and/or according to a desired stability of the cavity.

The reflector RaM1 may be partially reflective or highly reflective at the wavelength of the illuminating pulses LB3. The reflector RaM2 may be partially reflective at the wavelength of the illuminating pulses LB3. The reflector RaM2 may be partially transmissive at the wavelength of the illuminating pulses LB3.

Raman scattered light obtained from the Raman resonator crystal RaC1 may comprise e.g. 1st Stokes component at a wavelength λ_{S1}, 2nd Stokes component at a wavelength λ_{S2}, and/or 3rd Stokes component at a wavelength λ_{S3}. Raman scattered light obtained from the Raman resonator crystal RaC1 may comprise e.g. 1st anti-Stokes component at a wavelength λ_{S-1}.

The term “Stokes component” may mean a spectral component, which is emitted from the material of the crystal RaC1 by Raman scattering when said material is illuminated by light having a predetermined wavelength (e.g. λ_{LB2}). The Raman spectrum of said material may comprise one or more Stokes peaks and/or anti Stokes peaks when illuminated by light having said predetermined wavelength. Each Stokes peak may have a spectral position (e.g. λ_{S1}, λ_{S2}, λ_{S3}). Each anti-Stokes peak may have a spectral position (e.g. λ_{S-1}, λ_{S-2}, λ_{S-3}). The spectral position λ_{S1} of the first Stokes component may coincide with the spectral position of the first Stokes peak, which has the smallest spectral distance (λ_{S1}-λ_{LB2}) from said predetermined wavelength (λ_{LB2}). The spectral position λ_{S2} of the second Stokes component may coincide with the spectral position of the second Stokes peak, which has the second smallest spectral distance (λ_{S2}-λ_{LB2}) from said predetermined wavelength (λ_{LB2}). The spectral position λ_{S-1} of the first anti-Stokes component may coincide with the spectral position of the first anti-Stokes peak, which has the smallest spectral distance (λ_{LB2}-λ_{S-1}) from said predetermined wavelength (λ_{LB2}).

The 1st Stokes component may be e.g. at the wavelength 573 nm, the 2nd Stokes component may be e.g. at the wavelength 620 nm, and the 3rd Stokes component may be e.g. at the wavelength 676 nm. The apparatus 500 may be arranged to provide e.g. 1st, 2nd or 3rd Stokes line from the crystal RaC1 by stimulated Raman scattering. The conversion unit 100 may be arranged to provide 1st, 2nd, and/or 3rd Stokes component by selecting the spectral transmittance of the reflector RaM1 and/or by selecting the spectral transmittance of the reflector RaM2.

The apparatus 500 may comprise one or more filters FIL1 for removing un-wanted spectral components from light, which is coupled out of the resonator cavity 120. The conversion unit 100 may comprise one or more filters FIL1 for removing un-wanted spectral components from light, which is coupled out of the resonator cavity 120. The apparatus 500 may be arranged to form illuminating light LB3 from light coupled out of the cavity 120 such that the illuminating light LB3 may comprise only one spectral component at the wavelength λ_{S1}, λ_{S2}, or λ_{S3}. The filters FIL1 may be arranged to remove one or more un-wanted spectral components such that the illuminating light LB3 provided by the conversion unit 100 may comprise only one spectral component at the selected wavelength λ_{S1}, λ_{S2}, or λ_{S3}. For example, the one or more filters FIL1 may be arranged to reject spectral components at the wavelengths λ_{LB2}, λ_{S2}, and λ_{S3} in a situation where the sample MX is illuminated with light LB3, which has a spectral component at the wavelength λ_{S1}. For example, the one or more filters FIL1 may be arranged to reject spectral components at the wavelengths λ_{LB2}, λ_{S1}, and λ_{S3} in a situation where the sample MX is illuminated with light LB3, which has a spectral component at the wavelength λ_{S2}.

The Raman resonator cavity 120 may be arranged to produce one or more Stokes components and/or anti-Stokes components. Each Stokes (and/or anti Stokes) component may have a temporal intensity profile.

The first Stokes component may act as pump light for the second Stokes component. The second Stokes component may act as pump light for the third Stokes component. The maximum intensity of each Stokes component (and/or anti Stokes component) component may be significant or negligible. The maximum intensities of the different Stokes components may be selected e.g. by selecting the spectral reflectivity function of the reflectors RaM1, RaM2. R1(λ) may denote the spectral reflectivity function of the reflector RaM1. R2(λ) may denote the spectral reflectivity function of the reflector RaM2.

The reflector RaM1 and/or RaM2 may be implemented e.g. by using a multilayer coating and/or a volume Bragg grating. The reflectors may be substantially lossless, i.e. the transmittance T(λ) of the reflector may be substantially equal to 100% minus the reflectance R(λ), i.e. T(λ)=1−R(λ) at the wavelengths λ_{LB2}, λ_{S1}, λ_{S2}, λ_{S3}. The reflectance may also be called e.g. as reflection coefficient.

A method for producing the conversion unit 100 may comprise selecting the spectral reflectivity functions R1(λ), R2(λ) of the reflectors RaM1, RaM2.

For example, the resonator 120 may be arranged to generate illuminating light pulses LB3 primarily at the wavelength λ_{S1} of the 1st Stokes component in the following manner. In this case, the intensities at the wavelengths λ_{S2}, λ_{S3} of the 2nd and 3rd Stokes components may remain low.

The spectral reflectivity functions R1(λ), R2(λ) of the reflectors RaM1, RaM2 may be selected e.g. as follows: R1(λ_{S1})>70%, 30%<R2(λ_{S1})<80%, R1(λ_{S2})<15%, R2(λ_{S2})<15%, R1(λ_{S3})<15%, R2(λ_{S3})<15%. In addition, the spectral reflectivity functions R1(λ), R2(λ) may be selected such that R1(λ_{LB2})<50% and R2(λ_{LB2})>70% so as to effectively couple the light pulses LB2 into the resonator 120.

In particular, the spectral reflectivity functions R1(λ), R2(λ) of the reflectors RaM1, RaM2 may be selected as follows: R1(λ_{S1})>99%, 40%<R2(λ_{S1})<80%, R1(λ_{S2})<5%, R2(λ_{S2})<5%, R1(λ_{S3})<5%, R2(λ_{S3})<5%, R1(λ_{LB2})<15%, and R2(λ_{LB2})>99%.

If the reflectivity of RaM2 is reasonably low at the wavelength of the 1st Stokes line (e.g. 40%<R2(λ_{S1})<60%), then the lasing threshold may be high for the 1st Stokes component, lasing may be possible in the resonator 120 only during a short time window, the temporal width of the generated pulse LB3 may be short, and the Raman conversion efficiency may be low.

If the reflectivity of RaM2 is reasonably high at the wavelength of the 1st Stokes line (e.g. 60%<R2(λ_{S1})<80%), then the lasing threshold may be low for the 1st Stokes component, which may result in formation of a longer pulse LB3 with a higher efficiency.

The wavelength λ_{LB2} of the pump light LB2 may be e.g. 532 nm. The wavelength λ_{S1} of the first Stokes component may be e.g. 573 nm. The wavelength λ_{S2} of the 2nd Stokes component may be e.g. 620 nm. The wavelength λ_{S3} of the 3rd Stokes component may be e.g. 676 nm.

FIG. 3b shows, by way of example spectral reflectance R1(λ) of the reflector RaM1, spectral reflectance R2(λ) of the reflector RaM2, and a resulting spectrum of light coupled out of the cavity 120. The 1st Stokes component may represent e.g. more than 70% of the optical energy of light emitted from the cavity 120 by stimulated Raman scattering. The optical energy of the 1st Stokes component may be e.g. higher than 70% of the optical energy of light emitted from the cavity 120 by stimulated Raman scattering. The optical energy of the 1st Stokes component may be e.g. higher than 70% of the combined optical energy of the 1st, 2nd and 3rd Stokes components.

The apparatus 500 may comprise one or more optical filters FIL1 to remove un-wanted components from the light, which is coupled out of the cavity 120. For example, a filter FIL1 may be arranged to transmit only the 1st Stokes component so as to provide substantially monochromatic illuminating light pulses LB3.

The apparatus 500 may also be arranged to generate illuminating pulses LB3 primarily at the wavelength λ_{S2} of the 2nd Stokes component. The light pulses LB3 coupled out of the cavity 120 at the wavelength λ_{S2} may have very short temporal width (FIG. 3d). The conversion unit 100 may be arranged to form the illuminating pulses LB3 at the wavelength λ_{S2} of the second Stokes component of the stimulated Raman scattering.

The resonator 120 may be arranged to generate illuminating light pulses LB3 at the wavelength λ_{S2} of the 2nd Stokes component e.g. in the following manner.

The spectral reflectivity functions R1(λ), R2(λ) of the reflectors RaM1, RaM2 may be selected e.g. as follows: R1(λ_{S1})>70%, R1(λ_{S2})>70%, R1(λ_{S3})<15%, R2(λ_{S3})<15%, 30%<R2(λ_{S1})<80%, 30%<R2(λ_{S2})<80%. In addition, the spectral reflectivity functions R1(λ), R2(λ) may be selected such that R1(λ_{LB2})<50% and R2(λ_{LB2})>70% so as to effectively couple the light pulses LB2 into the resonator 120.

In particular, the spectral reflectivity functions R1(λ), R2(λ) of the reflectors RaM1, RaM2 may be selected as follows: R1(λ_{S1})>99%, R1(λ_{S2})>99%, R1(λ_{S3})<5%, R2(λ_{S3})<5%, 40%<R2(λ_{S1})<80%, 30%<R2(λ_{S2})<80%. R1(λ_{LB2})<15%, and R2(λ_{LB2})>99%.

FIG. 3c shows, by way of example spectral reflectance R1(λ) of the reflector RaM1, spectral reflectance R2(λ) of the reflector RaM2, and a resulting spectrum of light coupled out of the cavity 120.

The maximum intensity of the 2nd Stokes component emitted from the cavity 120 may be e.g. higher than 0.3 times the maximum intensity of the 1st Stokes component emitted from the cavity 120. The maximum intensity of the 2nd Stokes component may be e.g. higher than 0.7 times of the maximum intensity of the 1st Stokes component. The maximum intensity of the 2nd Stokes component may be even higher than the maximum intensity of the 1st Stokes component.

The 2nd Stokes component emitted from the cavity 120 may represent e.g. more than 30% of the combined optical energy of the 1st, 2nd and 3rd Stokes components. The optical energy of the 2nd Stokes component may be e.g. higher than 0.3 times the combined optical energy of the 1st, 2nd and 3rd Stokes components.

The apparatus 500 may comprise one or more optical filters FIL1 to remove un-wanted components from the light, which is coupled out of the cavity 120. For example, a filter FIL1 may be arranged to transmit only the 2nd Stokes component so as to provide substantially monochromatic illuminating light pulses LB3.

When the aim is to generate illuminating light pulses LB3 primarily at the wavelength λ_{S2} of the 2nd Stokes component, a method for selecting the spectral reflectivity function R2(λ) of the reflector RaM2 may comprise:
selecting a set of operating parameters (e.g. pulse energy, pulse duration, crystal length, crystal material, pump spot diameter),
selecting the value R2(λ_{S1}) for said set of parameters such that a substantial (about 30-60%) pulse shortening is obtained for the 1st Stokes pulse, in comparison to the pump pulse LB2, in a reference situation where the 2nd Stokes output is suppressed (e.g. by setting R2(λ_{S2})<5%),
after the value R2(λ_{S1}) has been selected, selecting R2(λ_{S2}) such that only one 2nd Stokes pulse (at λ_{S2}) is obtained per one pump pulse LB2 (at λ_{LB2}).

When the aim is to generate illuminating light pulses LB3 primarily at the wavelength λ_{S2} of the 2nd Stokes component, a method for selecting the spectral reflectivity function R2(λ) of the reflector RaM2 may comprise:
selecting a set of operating parameters (e.g. pulse energy, pulse duration, crystal length, crystal material, pump spot diameter),
selecting the value of R2(λ_{S1}) such that the temporal width Δt_{FWHM,S1} of the pulse LB3 at the wavelength λ_{S1} is in the range of 0.4 to 0.7 times the temporal width Δt_{FWHM,LB2} of the pulse LB2 at the wavelength λ_{LB2}, for said set of operating parameters, in a reference situation where the second Stokes component is suppressed,
after the value R2(λ_{S1}) has been selected, selecting R2(λ_{S2}) such that only one 2nd Stokes pulse (at λ_{S2}) is obtained per one pump pulse LB2 (at λ_{LB2}).

If the 1st Stokes pulse is too long, or if the mirror reflectivity RaM2 at 2nd Stokes is too high, it may be possible that a single pump pulse LB2 may generate more than one 2nd Stokes pulses. R2(λ_{S2}) may be lower than a predetermined limit and the temporal width of the 1st Stokes pulse may be shorter than a predetermined limit such that the resonator 120 generates only one light pulse LB3 at the wavelength λ_{S2} of the 2nd Stokes component. Generating only one 2nd Stokes pulse per one pump pulse LB2 may be advantageous when measuring a Raman spectrum of the sample MX by time gated detection. Generating only one 2nd Stokes pulse per one pump pulse LB2 may facilitate compensation of the fluorescence.

If R2(λ_{S1}) and R2(λ_{S2}) are too high, intra cavity intensity in the Raman crystal RaC1 may exceed the damage threshold of mirror coating materials of the reflector RaM1 and/or RaM2.

If the output coupling ratio of the resonator 120 is too low (e.g. when R1(λ_{S1}) and R2(λ_{S1}) are too high), this may cause a long pulse at the wavelength λ_{S1}. The long pulse at the wavelength λ_{S1} may cause two or more pulses at the 2nd Stokes wavelength λ_{S2}. For example, the first 2nd Stokes pulse may rise rapidly and deplete pumped energy temporarily below a required threshold. Another 2nd Stokes pulse may appear if the pump, i.e. the 1st Stokes pulse, is able to recover and gain enough energy to support another 2nd Stokes pulse. All this may happen during one the pumping period of a single pump pulse LB2 (e.g. at 532 nm).

An optimum reflectance function R2(λ) may depend e.g. on the intensity of the pump light LB2, on the length of the Raman crystal RaC1, on the material of the Raman crystal RaC1, and on the diameter of the light beam LB2 in the crystal RaC1

The pump spot diameter of the beam LB2 in the crystal RaC1 may be e.g. in the range of 10 to 100 μm. The lower limit for the spot size may be determined by the damage threshold of the reflectors RaM1, RaM2. The stimulated Raman emission may require high intensity pumping, which may set an upper limit for pump spot diameter (for a given energy of a pump pulse). If the pump spot diameter is too narrow, the gain of the resonator 120 may be high, which in turn may lead to a longer output pulse (or to multiple output pulses) and to higher conversion efficiency.

A larger pump spot may result in smaller pump intensity and a shorter output pulse, as the temporal window of positive net gain of the resonator 120 may be shorter. This may also lead to reduced conversion efficiency. If the pump spot diameter is too wide, the gain of the resonator 120 may be too low for generating light by stimulated Raman scattering.

The pump spot diameter may be arranged to substantially match with the diameter of the fundamental transverse mode (TEM00) diameter of the generated light LB3, e.g. in order to suppress higher order transversal modes and provide high conversion efficiency to the fundamental laser mode.

The resonator 120 may generate light LB3 simultaneously at several wavelengths. The apparatus 500 may comprise a spectrally selective filter for providing illuminating light pulses LB3 a selected wavelength. The spectrally selective filter may be arranged to block spectral components at undesired wavelengths.

The reflector RaM1 and/or RaM2 may be arranged to reflect a part of the illuminating pulses LB3 back into the Raman crystal RaC1, so as to stimulate the Raman scattering. To the first approximation, the intensity of light pulses LB3 emitted from the crystal RaC1 may be substantially proportional to the product I_{λLB2,RaC1}·I_{λLB3 RaC1} of a first intensity I_{λLB2,RaC1} and a second intensity value I_{λLB3 RaC1} wherein the first intensity value I_{λLB2,RaC1} may be equal to the intensity of light at the wavelength λ_{LB2} in the crystal RaC1, and the second intensity value I_{λLB3 RaC1}, may be equal to the intensity of light at the wavelength λ_{LB3} in the crystal RaC1. The Raman scattering may be stimulated by feeding a part of the generated illuminating light pulses LB3 back into the Raman crystal RaC1. The efficiency of the Raman conversion in the crystal RaC1 may be increased by feeding a part of the light LB3 back to the Raman crystal RaC1.

At least one of the reflectors RaM1 and/or RaM2 may be arranged to transmit light at the wavelength of the illuminating pulses LB3, so that the illuminating pulses LB3 may be coupled out of the crystal RaC1 to the sample MX.

A part LB1′ of the laser light pulses LB1 may be transmitted through the crystal NLC1. The conversion unit 100 may comprise e.g. a spectrally selective reflector DM1 to separate the transmitted laser pulses LB1′ from the light LB2. The conversion unit 100 may optionally comprise e.g. a beam dump BD1 to absorb energy of laser pulses LB1′ transmitted through the crystal NLC1.

The wavelength of the laser pulses LB1 may be e.g. 1064 nm. The crystal RaC1 may comprise e.g. diamond or a doped diamond. The wavelength of the illuminating pulses LB3 may be e.g. 573 nm, 620 nm, or 676 nm. The wavelength of the illuminating pulses LB3 may be selectable from a group consisting of 573 nm, 620 nm, and 676 nm. The wavelength of the illuminating pulses LB3 may be selected e.g. by using a spectrally selective filter.

The wavelength of laser pulses coupled into the conversion unit may be e.g. 1064 nm, wherein the wavelength of the harmonic pulses may be 532 nm. When using a diamond crystal and the harmonic (pump) wavelength of 532 nm, the conversion unit may provide illuminating light pulses at one or more wavelengths selected from a group of 573 nm, 620 nm ja 676 nm. Using the diamond crystal may allow selecting a wavelength from the group of 573 nm, 620 nm and 676 nm. Yet, the conversion unit may provide illuminating pulses simultaneously at two or more wavelengths selected from a group of 573 nm, 620 nm and 676 nm. The conversion unit 100 may be arranged to simultaneously form illuminating pulses LB3 at two or more wavelengths selected from a group consisting of 573 nm, 620 nm, and 676 nm.

FIG. 3d shows, by way of example, temporal shape I_{LB2}(t) of a pump light pulse LB2 coupled into the cavity 120 through the reflector RaM1, temporal shape I_{S1}(t) of the 1st Stokes component coupled out of the cavity 120 through the reflector RaM2, and temporal shape I_{S2}(t) of the 2nd Stokes component coupled out out of the cavity 120 through the reflector RaM2.

Generation of the 2nd Stokes component (at 620 nm) may have an effect on the temporal profile of the light pulse LB3 at the wavelength (573 nm) of the 1st Stokes component. For example, generation of the 2nd Stokes component may cause a depression (“dent”) in the temporal intensity profile of the light pulse LB3 at the wavelength of the 1st Stokes component.

Generation of the 3rd Stokes component (at 676 nm) may have an effect on the temporal profile of the light pulse LB3 at the wavelength (620 nm) of the 2nd Stokes component. For example, generation of the 3rd Stokes component may cause a depression (“dent”) in the temporal intensity profile of the light pulse LB3 at the wavelength of the 2nd Stokes component.

Referring to FIG. 3e, the crystal NLC1 and the crystal RaC1 of the pulse conversion unit 100 may be connected optically in series so as to produce illuminating light pulses LB3, which have a reduced temporal width Δt_{FWHM,LB3}.

An individual laser light pulse LB1 may have a rise time Δt_{RISE}, and a fall time Δt_{FALL}. The rise time may be defined e.g. by points where the intensity increases from 10% to 90% of the maximum value. The fall time may be defined e.g. by points where the intensity decreases from 90% to 10% of the maximum value. The rise time Δt_{RISE} and the fall time Δt_{FALL} of the input light pulses LB1 may be greater than zero. The crystal NLC1 may form a harmonic pulse LB2 such that the intensity of the harmonic pulse LB2 is substantially proportional to the square of the intensity of an input pulse LB1. Consequently, the crystal NLC1 may form the harmonic light pulses LB2 such that the temporal width Δt_{FWHM,LB2} of the harmonic light pulses LB2 is substantially smaller than the temporal width Δt_{FWHM,LB1} of the input light pulses LB1.

The temporal width Δt_{FWHM,LB3} of the illuminating pulses LB3 may be e.g. in the range of 25% to 60% of the temporal width Δt_{FWHM,LB1} of the pulses LB1. The temporal width Δt_{FWHM,LB1} of the laser light pulses LB1 may be e.g. longer than or equal to 50 ps. The temporal width Δt_{FWHM,LB3} of the illuminating pulses LB3 may be e.g. in the range of 25 to 50 ps.

The temporal width Δt_{FWHM,ARR} of the response function h(t) of the detector array ARR1 may be e.g. in the range of 25 to 50 ps.

The rise time Δt_{RISE} and the fall time Δt_{FALL} of the harmonic light pulses LB2 may be greater than zero. The conversion unit 100 may comprise reflectors RaM1, RaM2. The conversion unit 100 may comprise an optical cavity 120 defined by the reflectors RaM1, RaM2. The crystal RaC1 may operate in the optical cavity 120 defined by the reflectors RaM1, RaM2. The reflectors RaM1, RaM2 may feed a part of a generated light pulse LB3 back into the crystal RaC1 such that the light pulse LB3 may be generated by stimulated Raman scattering. Thus, the relationship between the intensity of the light pulse LB2 and the intensity of the light pulse LB3 may be nonlinear such that the temporal width Δt_{FWHM,LB3} of the pulses LB3 is substantially smaller than the temporal width Δt_{FWHM,LB2} of the pulses LB2.

The light pulses LB2 may be guided into the crystal RaC1 as a light beam. The duration of the pulses LB3 may depend e.g. on the spatial width of light beam LB2 in the crystal RaC1, on the intensity of the pulses LB2, on the temporal width of the pulses LB2, on the reflection coefficients of the reflectors RaM1, RaM2, on the material of the crystal RaC1, and on the length of the cavity 120. In particular, the length of the crystal RaC1 and the length of the cavity 120 may be short, which may facilitate providing short light pulses LB3. The length of the cavity 120 may be e.g. in the range of 0.1 mm to 5 mm.

The crystal NLC1 and the crystal RaC1 may be coupled optically in series such that the temporal width Δt_{FWHM,LB3} of the illuminating light pulses LB3 is substantially shorter than the temporal width Δt_{FWHM,LB1} of the illuminating light pulses LB1.

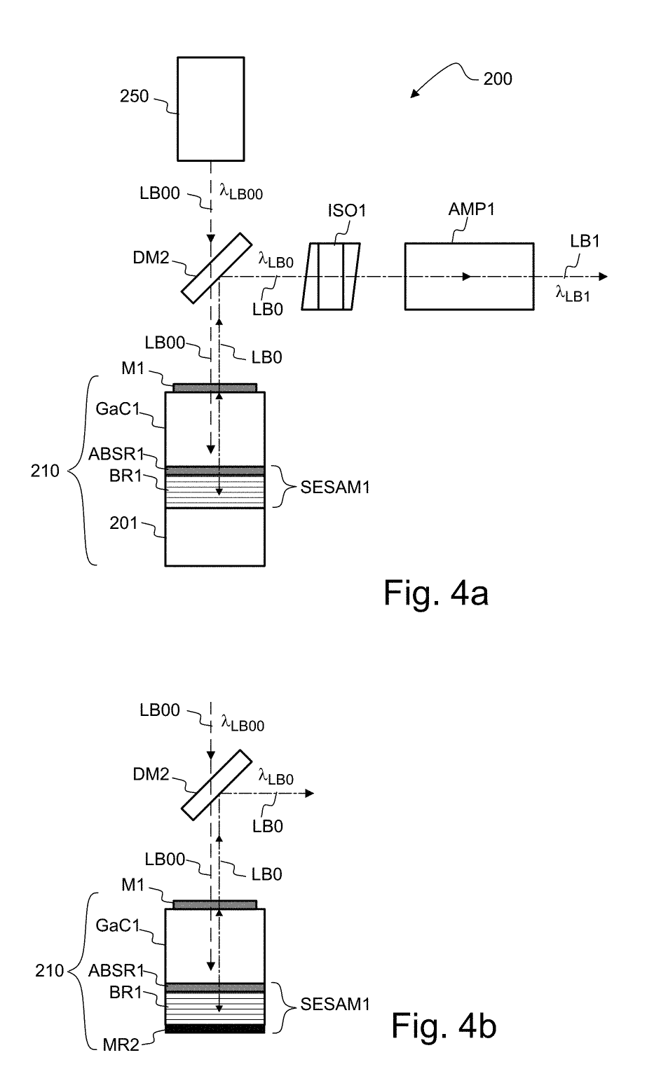

Referring to FIG. 4a, the apparatus 500 may comprise a microchip laser 210, which comprises a saturable absorber mirror SESAM1 bonded to a gain crystal GaC1. The laser unit 200 may comprise a Q-switched microchip laser 210. The microchip laser 210 may comprise laser gain crystal GaC1, a saturable absorber section ABSR1, and a reflector BR1. The gain crystal GaC1 may be e.g. a neodymium-doped YVO₄ crystal (Nd:YVO₄). The gain crystal GaC1 may be e.g. a plate, which has substantially planar surfaces. The length of the gain crystal GaC1 (in the direction of propagation of the light) may be e.g. in the range of 50 μm to 200 μm.

The absorber section ABSR1, and the reflector BR1 may together form a semiconductor saturable absorber mirror (SESAM) SESAM1. The saturable absorber mirror SESAM1 may act as a passive Q-switching element. The saturable absorber mirror SESAM1 may be bonded to the gain crystal GaC1 so as to provide stable optical coupling between the saturable absorber mirror SESAM1 and the gain crystal GaC1. The saturable absorber mirror SESAM1 and the gain crystal GaC1 may together form a monolithic entity.

The absorber ABSR1 may comprise semiconductor quantum wells, semiconductor quantum dots and/or bulk semiconductor material.

The reflector BR1 may be a distributed Bragg reflector. The reflector BR1 and the absorber section ABSR1 may be implemented e.g. on a substrate 201. The substrate may comprise e.g. gallium arsenide (GaAs). The distributed Bragg reflector BR1 may comprise e.g. a plurality of material layers selected from GaAs, AlAs and AlGaAs. The reflector BR1 may also be a metallic reflector. The reflector BR1 may also be a hybrid reflector, which comprises a combination of semiconductor, and/or dielectric layers and/or a metal reflector (FIG. 4b).

One surface of the gain crystal GaC1 may be coated with a reflective coating

M1. The coating M1 may allow high transmission of pump light LB00 into the crystal GaC1, may transmit of part of generated laser light LB0 out of the crystal GaC1, and may reflect a part of generated laser light LB0 back to the crystal GaC1 so as to provide optical feedback.

The coating M1 and the reflector BR1 may together define an optical resonator cavity of the microchip laser 210. The plane-plane laser cavity may be stabilized by a thermal lens, which may be formed inside the gain crystal GaC1 by a thermal gradient caused by the optical pumping.

The laser unit 200 may comprise a pump light source 250 to provide pump light LB00. The pump light source 250 may be e.g. a diode laser.

The wavelength λ_{LB00} of the pump light LB00 may be e.g. 808 nm. The wavelength λ_{LB0} of the laser light pulses LB0 may be e.g. 1064 nm. The wavelength λ_{LB1} of the amplified laser light pulses LB1 may be equal to the wavelength λ_{LB0} of the laser light pulses LB0.

The gain crystal GaC1 may be optically pumped by using the pump light LB00. The laser unit 200 may comprise e.g. a dichroic component DM2 for coupling the pump light LB00 to the gain crystal GaC1 and for separating the generated laser light LB0 from the optical path of the pump light LB00. Laser light generated LB0 by the microchip laser 210 may be amplified by using an optical amplifier AMP1. The laser unit 200 may comprise an optical amplifier AMP1 to provide laser light pulses LB1 by amplifying laser light pulses LB0 generated by the microchip laser 210.

The laser unit 200 may comprise an optical isolator ISO1 to prevent coupling of disturbing feedback to the gain crystal GaC1. The optical isolator ISO1 may be positioned e.g. between the microchip laser 210 and the amplifier AMP1.

The saturable absorber mirror SESAM1 may provide suitable amount of saturable absorption in a very short distance, which in turn allow providing a short optical cavity. The short cavity may provide short laser pulses LB0, LB1. The duration of the laser pulses LB0, LB1 may be e.g. shorter than 100 ps.

Light pulses LB0 generated by the microchip laser 201 may be coupled to the conversion unit 100 in order to generate the illuminating light pulses LB3. In that case the light pulses LB0 may be used as the input laser light pulses LB1 for the conversion unit 100.

The pulse energy from the microchip laser 210 may be kept below a predetermined limit in order to protect the saturable absorber mirror SESAM1 from catastrophic optical damage and/or in order to protect the saturable absorber mirror SESAM1 from slower damage mechanisms. The pulse energy may be kept below the predetermined limit e.g. by using the optical booster amplifier AMP1.

The laser 210 and the optical amplifier AMP1 may together form a master oscillator power amplifier system (MOPA), where a low power master oscillator is used for generating short laser pulses, and a separate power amplifier is used for boosting the optical power. The master oscillator 210 may be separated from the amplifier AMP1 e.g. by the optical isolator ISO1 in order to avoid disturbing optical feedback to the master oscillator 210 from later units of the system.

The amplifier AMP1 may comprise e.g. a crystal doped with neodymium, e.g. Nd:YVO₄ or Nd:YAG. The amplifier AMP1 may comprise light-amplifying glass. The amplifier AMP1 may be optically pumped by using pump light. The amplifier AMP1 may be pumped e.g. by using pump light at the wavelength 808 nm. The amplifier AMP1 may comprise light-amplifying optical fiber. The amplifier AMP1 may comprise e.g. light-amplifying Yb-doped optical fiber, which may be pumped by using pump light at the wavelength 976 nm. The amplifier AMP1 may comprise one or more optical amplifier stages. The amplifier AMP1 may comprise two or more cascaded amplifier stages.

The amplifier AMP1 may be arranged to operate such that the effective mode area of light LB0, LB1 in the light-amplifying medium is larger than a predetermined limit, in order to minimize spectral broadening.

Short and intense light pulses LB0 may reduce the operating lifetime of the saturable absorber mirror SESAM1. The laser 210 may be arranged to operate such that the duration of light pulses is greater than or equal to a predetermined limit in order to provide a longer operating lifetime of the laser 210.

The laser 210 may be arranged to operate such that the duration of light pulses LB0, LB1 provided by the microchip laser 210 is e.g. greater than or equal to 25 ps, in order to reduce the risk of damaging the saturable absorber mirror SESAM1. The laser 210 may be arranged to operate such that the duration of light pulses LB0, LB1 is e.g. in the range of 25 ps to 100 ps.

The laser 210 may be arranged to operate such that the duration of light pulses LB0, LB1 is e.g. greater than or equal to 40 ps, in order to reduce the risk of damaging the saturable absorber mirror SESAM1. The laser 210 may be arranged to operate such that the duration of light pulses LB0, LB1 is e.g. in the range of 40 ps to 100 ps.

The laser 210 may be arranged to operate such that the duration of light pulses LB0, LB1 is e.g. greater than or equal to 50 ps, in order to reduce the risk of damaging the saturable absorber mirror SESAM1. The laser 210 may be arranged to operate such that the duration of light pulses LB0, LB1 is e.g. in the range of 50 ps to 100 ps.

The microchip laser may be used together with the conversion unit in order to provide high peak intensity and in order to provide high conversion efficiency.

Referring to FIG. 4b, the microchip laser 210 may comprise a hybrid reflector, which comprises a combination of a Bragg reflector BR1 and a metal reflector MR1.

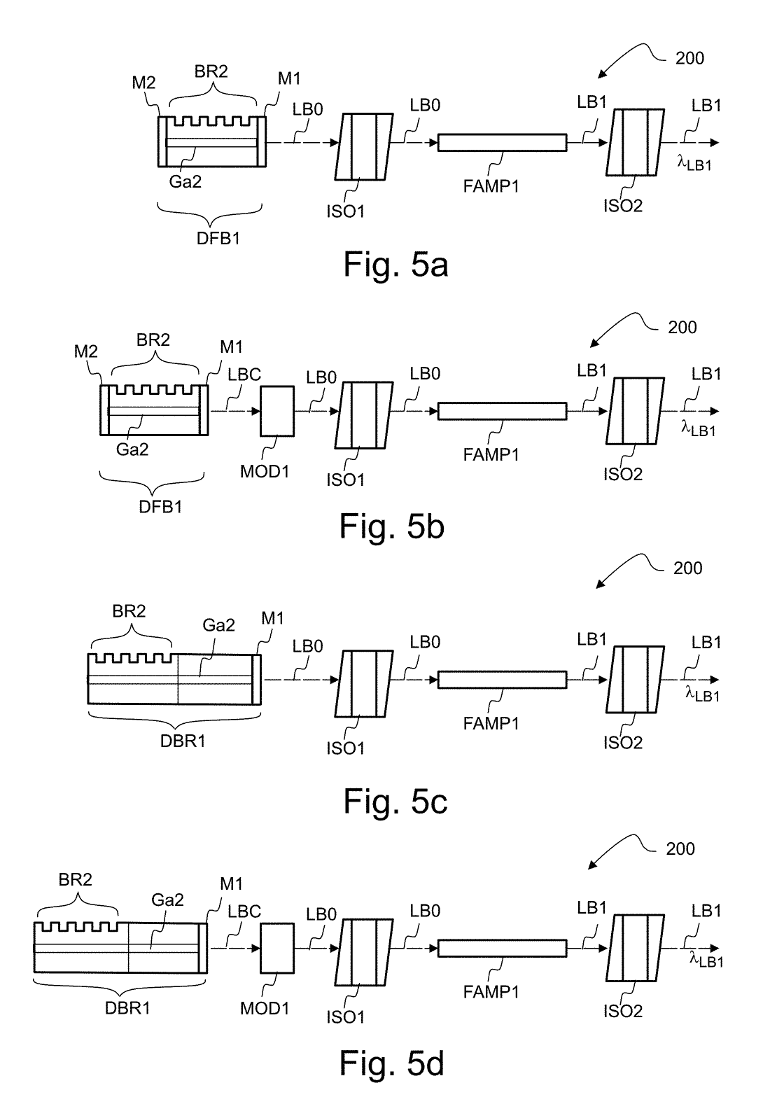

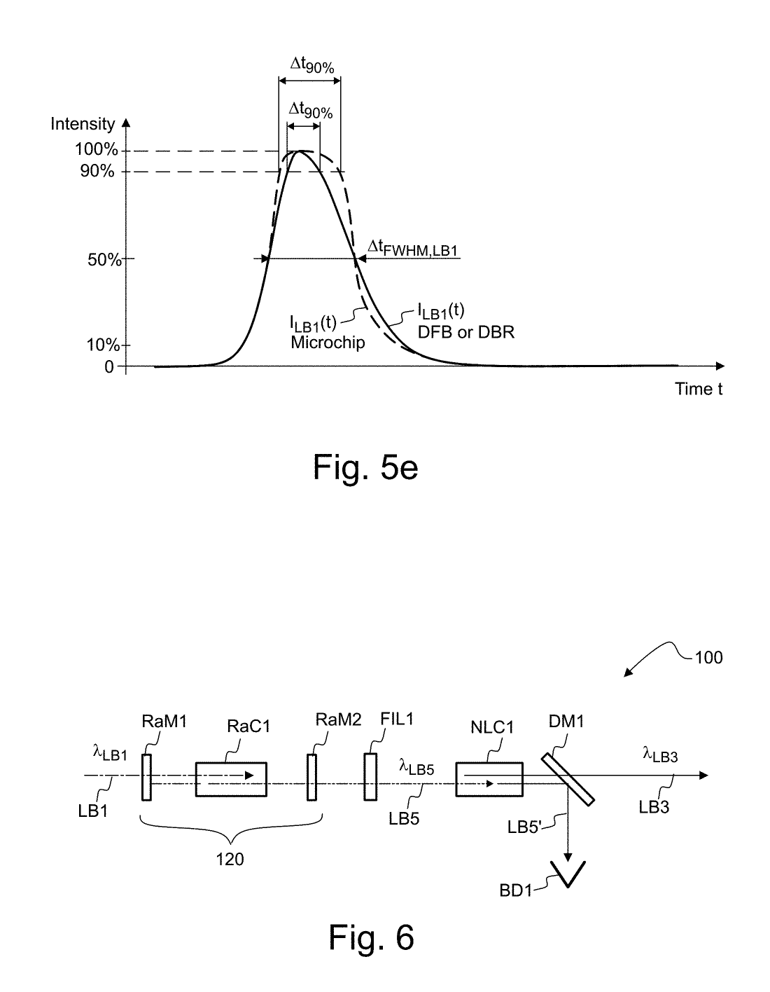

FIG. 5a shows a laser unit 200, which comprises a distributed feedback laser diode DFB1, and an optical amplifier FAMP1. Laser pulses LB1 generated by the laser unit 200 may be coupled into the conversion unit 100 in order to generate the illuminating light pulses LB3. The distributed feedback laser DFB1 may comprise an optical cavity defined by reflectors M1, M2. The optical cavity may comprise an optical waveguide Ga2, which comprises gain medium. The gain medium may be electrically pumped. The gain medium may amplify light by stimulated emission. The distributed feedback laser DFB1 may comprise a feedback grating BR2 to provide spectrally selective optical feedback. The feedback grating BR2 may be implemented e.g. on a cladding layer of the optical waveguide Ga2. The reflector M1 may be partially transmissive in order to couple light pulses LB0 out of the cavity. The laser unit 200 may comprise an optical amplifier FAMP1 to provide laser pulses LB1 by amplifying the light pulses LB0. The distributed feedback laser DFB1 may be electrically modulated in order to generate pulsed light LB0.

FIG. 5b shows a laser unit 200, which comprises a distributed feedback laser diode DFB1, an optical modulator MOD1, and an optical amplifier FAMP1. Laser pulses LB1 generated by the laser unit 200 may be coupled into the conversion unit 100 in order to generate the illuminating light pulses LB3. The distributed feedback laser DFB1 may comprise an optical cavity defined by reflectors M1, M2. The optical cavity may comprise an optical waveguide Ga2, which comprises gain medium. The gain medium may be electrically pumped. The gain medium may amplify light by stimulated emission. The distributed feedback laser DFB1 may comprise a feedback grating BR2 to provide spectrally selective optical feedback. The feedback grating BR2 may be implemented e.g. on a cladding layer of the optical waveguide Ga2. The reflector M1 may be partially transmissive in order to couple light LBC out of the cavity. The laser unit 200 may comprise an optical amplifier FAMP1 to provide laser pulses LB1 by amplifying the light pulses LB0. The laser unit 200 may comprise the optical modulator MOD1 to generate pulsed light LB0 from the light LBC.

FIG. 5c a laser unit 200, which comprises a distributed Bragg reflector laser diode DBR1, and an optical amplifier FAMP1. Laser pulses LB1 generated by the laser unit 200 may be coupled into the conversion unit 100 in order to generate the illuminating light pulses LB3. The distributed Bragg reflector laser DBR1 may comprise an optical cavity defined by a reflector M1 and a feedback Bragg grating BR2. The optical cavity may comprise an optical waveguide Ga2, which comprises gain medium. The gain medium may be electrically pumped. The gain medium may amplify light by stimulated emission. The reflector M1 may be partially transmissive in order to couple light pulses LB0 out of the cavity. The laser unit 200 may comprise an optical amplifier FAMP1 to provide laser pulses LB1 by amplifying the light pulses LB0. The distributed feedback laser DFB1 may be electrically modulated in order to generate pulsed light LB0.

FIG. 5d shows a laser unit 200, which comprises a distributed Bragg reflector laser DBR1, an optical modulator MOD1, and an optical amplifier FAMP1. Laser pulses LB1 generated by the laser unit 200 may be coupled into the conversion unit 100 in order to generate the illuminating light pulses LB3. The distributed Bragg reflector laser DBR1 may comprise an optical cavity defined by a reflector M1 and a feedback Bragg grating BR2. The optical cavity may comprise an optical waveguide Ga2, which comprises gain medium. The gain medium may be electrically pumped. The gain medium may amplify light by stimulated emission. The reflector M1 may be partially transmissive in order to couple light LBC out of the cavity. The laser unit 200 may comprise an optical amplifier FAMP1 to provide laser pulses LB1 by amplifying the light pulses LB0. The laser unit 200 may comprise the optical modulator MOD1 to generate pulsed light LB0 from the light LBC.

The laser unit 200 of FIG. 5a, 5b, 5c or 5d may be arranged to produce laser light pulses LB1 such that the duration of a laser pulse is e.g. shorter than 100 ps. The conversion unit 100 may provide shortened illuminating light pulses LB3 from the optical energy of the laser pulses LB1. The repetition rate of the laser pulses LB1 may be e.g. in the range of 1 MHz to 100 Mhz.

The laser unit 200 may also be arrange to produce single laser light pulses LB1 or pulse sequences on demand, according to a trigger signal S_{TRG}.

The modulator MOD1 may comprise e.g. a Mach-Zehnder modulator, an electro-optic modulator, or an electro-absorption modulator.

The amplifier FAMP1 may comprise e.g. one or more optical fiber amplifiers. The amplifier FAMP1 may comprise e.g. Ytterbium-doped light-amplifying optical fiber. The laser unit 200 may provide light LB1 whose wavelength λ_{LB1} is e.g. in the range of 1000 nm-1100 nm. The laser unit 200 may provide light LB1 whose wavelength λ_{LB1} is e.g. substantially equal to 1030 nm. A laser unit 200, which comprises ytterbium-doped light-amplifying optical fiber amplifier FAMP1 may provide light LB1 at the wavelength 1030 nm. The amplifier FAMP1 may comprise a tapered optical fiber in order to reduce harmful effects of nonlinear phenomena, which might take place in said optical fiber. The tapered optical fiber may reduce e.g. the effect of stimulated Brillouin scattering. The tapered optical fiber may have a narrower input end for the light LB0 and a broader output end for light LB1. The narrower input end may provide high coupling efficiency, and the broader output end may reduce the harmful effects of nonlinear phenomena.

The laser unit 200 may comprise optical isolators ISO1, ISO2 to reduce or avoid disturbing optical feedback.

The distributed feedback laser DFB1 or the distributed Bragg reflector laser DBR1 may comprise an optical amplifier. The optical amplifier may be a tapered semiconductor optical amplifier. The optical amplifier and the waveguide may be implemented on the same substrate. The semiconductor optical amplifier may be used in addition to the amplifier FAMP1 or instead of the amplifier FAMP1.

FIG. 5e illustrates, by way of example, a possible difference between the temporal shape of a laser pulse LB1 generated by using a microchip laser (e.g. by the laser unit of FIG. 4a) and the temporal shape of a laser pulse LB1 generated by using a DFB or DBR laser (e.g. by the laser unit of FIG. 5a, 5b, 5c or 5d). If the temporal shapes are normalized such that they have the same maximum value (100%) and the same width Δt_{FWHM,LB1}, then the laser pulse generated by the DFB or DBR laser may have a flatter top when compared with the laser pulse generated by the microchip laser. Δt_{90%} may denote the temporal width of defined by the points where the intensity is equal to 90% of the maximum value. The temporal width may be called e.g. as the width of the top of the laser pulse. The ratio Δt_{90%}/Δt_{FWHM,LB1} of the pulse generated by using the DFB or DBR laser may be substantially greater than the ratio Δt_{90%}/Δt_{FWHM,LB1} of the pulse generated by using the microchip laser.

If the temporal shapes of the laser pulses LB1 are normalized such that the pulses LB1 have the same energy and the same width Δt_{FWHM,LB1}, then the maximum intensity of the pulse LB1 generated by using the DFB or DBR laser may be substantially lower than the maximum intensity of the pulse LB1 generated by using the microchip laser.

FIG. 6 shows an alternative pulse conversion unit 100, which may form light pulses LB3 from optical energy of input laser pulses LB1. When compared with the conversion unit of FIG. 3a, the resonator 120 and the crystal NLC1 are in the different order. The apparatus 500 may comprise the alternative unit 100 of FIG. 6 instead of the unit shown in FIG. 3a.

Laser light pulses LB1 obtained from the laser unit 200 may be coupled to the Raman crystal RaC1. The Raman crystal RaC1 may provide Raman shifted light LB5 from the optical energy of the laser light pulses LB1 by stimulated Raman scattering. Light LB5 provided by the Raman crystal RaC1 may be coupled into the frequency conversion crystal NLC1. The crystal NLC1 may generate the illuminating light pulses LB3 from the optical energy of the pulses LB5 e.g. by second harmonic generation or by third harmonic generation. In particular, the wavelength of the illuminating light pulses LB1 may be substantially equal to 50% of the wavelength of the Raman-shifted light pulses LB5.

The conversion unit 100 may comprise an optical resonator cavity 120 defined by reflectors RaM1, RaM2. The resonator cavity 120 may comprise the crystal RaC1. In particular, the reflectors RaM1, RaM2 may be implemented on the crystal RaC1. The reflector RaM1 may have high reflectivity at the wavelength λ_{LB5} of the shifted pulses LB5. The reflector RaM2 may be partially reflective at the wavelength of the shifted pulses LB5. The reflector RaM2 may be partially transmissive at the wavelength of the shifted pulses LB5. The Raman crystal RaC1 may comprise e.g. diamond, boron doped diamond, barium nitrate, or potassium gadolinium tungstate (KGW). The crystal NLC1 may comprise or consist of e.g. Lithium Triborate (LBO), Lithium niobate (LN), Potassium Dideuterium Phosphate (KDP), Beta Barium Borate (BBO) or Potassium titanyl phosphate (KTP). The crystal NLC1 may be periodically poled.

A part LB5′ of the laser light pulses LB5 may be transmitted through the crystal NLC1. The conversion unit 100 may comprise e.g. a spectrally selective reflector DM1 to separate the transmitted light pulses LB5′ from the light of the illuminating pulses LB3. The conversion unit 100 may optionally comprise e.g. a beam dump BD1 to absorb energy of pulses LB5′.

The resonator 120 may be arranged to selectively provide 1st, 2nd, or 3rd Stokes component of the light LB5, e.g. by selecting the spectral transmittances of the reflectors RaM1, RaM2 in a similar manner as in case of the embodiment described with reference to FIG. 3a.

For example, the resonator 120 may be arranged to operate such that the laser light pulses LB1 have a wavelength 1064 nm, 1st Stokes component of the Raman shifted light LB5 has a wavelength 1240 nm, and the illuminating light pulses generated by the crystal NLC1 have a wavelength 620 nm (=0.5·1240 nm).

For example, the resonator 120 may be arranged to operate such that the laser light pulses LB1 have a wavelength 1064 nm, Raman shifted light LB5 is provided at the wavelength of the 2nd Stokes component, and the crystal NLC1 may form the light LB3 from the light pulses LB5 by second harmonic generation.

This arrangement may provide an increased wavelength difference λ_{LB1}-λ_{LB3}, as the crystal NLC1 may multiply the Raman shift e.g. by the factor of two. When using the conversion unit of FIG. 6, the Raman shift caused by the crystal RaC1 may be effectively doubled by the crystal NLC1. The conversion unit 100 of FIG. 6 may provide a larger spectral shift when compared with the conversion of unit of FIG. 3a. The wavelength of the illuminating light pulses LB1 provided by the conversion unit of FIG. 6 may be longer than the wavelength of the illuminating light pulses LB1 provided by the conversion unit of FIG. 3a.

The conversion unit 100 of FIG. 3a may provide higher total conversion efficiency when compared with the conversion of unit of FIG. 6. Also the conversion unit 100 of FIG. 6 may provide shortened light pulses LB1, when compared with the duration of the laser light pulses LB1.

In an embodiment, the conversion unit 100 may be selected according to the composition of the sample MX. The conversion unit 100 of FIG. 3a or the conversion unit 100 of FIG. 6 may be selected such that a spectral intensity of fluorescence from the sample MX may be reduced, when compared with a spectral intensity Raman scattered radiation from said sample MX.

The optical cavity 120 of the conversion unit 100 may comprise a crystal RaC1, where the reflectors RaM1, RaM2 have been implemented on the crystal RaC1. The reflector RaM1 and/or RaM2 may be comprise e.g. a dielectric multilayer coating. The reflector RaM1 and/or RaM2 may be comprise e.g. a volume Bragg grating.

In an embodiment, the spectral position of the illuminating light pulses LB3 generated by the conversion unit 100 may be stabilized by injecting an auxiliary seed laser beam into the crystal RaC1 of the resonator 120. The auxiliary seed laser beam may be e.g. a continuous beam. The auxiliary seed laser beam may be obtained e.g. from an auxiliary diode laser.

The detector ARR1 may comprise a plurality of detector pixels P1. The detector ARR1 may comprise one or more detector pixels P1, P2, . . . Pk, . . . PN.

An individual detector pixel P1 or a counter associated with the detector pixel may be arranged to provide a signal value b, which may be proportional to the integral of the total spectral intensity I_{LB4}(t,λ) over an integration time period, wherein said signal value b may also be proportional to the integral of the total spectral intensity I_{LB4}(t,λ) over a spectral passband, which has a center at a wavelength λ. The central wavelength λ of the passband associated with a detector pixel may depend on the position of said detector pixel with respect to the spectral disperser 350.

The spectral intensity I_{LB4}(t,λₖ) of the scattered radiation may have a value b₀ at a time t₀. The intensity I_{LB4}(t,λₖ) may have a value b1 at a time t₁. The intensity I_{LB4}(t,λₖ) may have a value b₂ at a time t₂. The intensity I_{LB4}(t,λₖ) may have a value b₃ at a time t₃. The values b₀, b₁, b₂, b₃ may be obtained by using the detector pixels of the detector ARR1. The detector ARR1 may provide e.g. a one-dimensional array or two-dimensional array of measured values b, which may represent different spectral positions λ₁, λ₂, . . . λₖ, and/or different timings t₀, t₁, t₂, t₃. The detector ARR1 may provide e.g. a one-dimensional array [b(λ₁), b(λ₂), . . . b(λₖ), . . . b(λ_{N})] of measured values b such that the array has a spectral dimension. The detector ARR1 may provide e.g. a one-dimensional array [b(t₀), b(t₁), b(t₂), b(t₃)] of measured values b such that the array has a temporal dimension. The values b(t₀), b(t₁), b(t₂), b(t₃) may also be denoted by symbols b₀, b₁, b₂, b₃, respectively.

The detector ARR1 may provide e.g. a two-dimensional array [b(t₀,λ₁), b(t₀,λ₂), . . . b(t₀,λₖ), . . . b(t₀,λ_{N}), b(t₁,λ₁), b(t₁,λ₂), . . . b(t₁,λₖ), . . . b(t₁,λ_{N}), . . . ] of measured values b such that the array has a temporal dimension and a spectral dimension. The values b(t₀,λ₁), b(t₀,λ₂), . . . b(t₀,λₖ), b(t₀,λ_{N}), b(t₁,λ₁), b(t₁,λ₂), . . . b(t₁,λₖ), . . . b(t₁,λ_{N}), . . . may also be denoted by symbols b_{0,0}, b_{0,1}, . . . b_{0,k}, . . . b_{0,N}, b_{1,0}, b_{1,1}, . . . b_{1,k}, . . . b_{1,N}, . . . , respectively.

Referring to FIG. 7a, a detector pixel P1, P2 may comprise a single photon avalanche diode (SPAD). In particular, a detector pixel P1, P2 may comprise a CMOS SPAD. CMOS is an acronym for Complementary Metal Oxide Semiconductor. The single photon avalanche diode may also be called e.g. as a Geiger mode avalanche photodiode. The single photon avalanche diode comprises a p-n junction, which may be reverse-biased such that a single charge carrier injected into the depletion layer of the p-n junction may trigger a self-sustaining avalanche of charge carriers. The single charge carrier may be generated by a photon hν. In the beginning of the avalanche, the current through the p-n junction may rapidly rise so that the leading edge of the avalanche current pulse may mark the arrival time of the detected photon hν. The rapid change of the current through the p-n junction may be detected by a suitable electronic circuit. The current through the p-n junction may continue until the avalanche is quenched. The single photon avalanche diode may be used together with a quenching circuit, which may be arranged to quench an avalanche current caused by a photon. The single photon avalanche diode may be used together with a quenching circuit, which may be arranged to quench an avalanche current caused by a photon. The apparatus 500 may comprise an electronic unit, which may be arranged to detect a rapid chance of the avalanche current and also to quench the avalanche current. Thus, a single photon avalanche diode may comprise a reverse-biased p-n junction, wherein each photon hν impinging on an active area of the single photon avalanche diode may be arranged cause a detectable current pulse with a probability, which is substantially greater than zero. The detection probability may also be called e.g. as a quantum efficiency. The quantum efficiency of the single photon avalanche diode may be e.g. greater than 20% for photons hν in a predetermined wavelength range. The quantum efficiency of a single photon avalanche diode may be e.g. greater than 20% for photons in the range of 400 nm to 900 nm. The quantum efficiency of a single photon avalanche diode may be e.g. greater than 30% for photons in the range of 440 nm to 680 nm. The quantum efficiency of a single photon avalanche diode may be e.g. greater than 40% for photons in the range of 470 nm to 630 nm.

Detector pixels of the detector ARR1 may be arranged as a one-dimensional spatial array in order to measure a spectrum, which corresponds to a single integration period. The detector ARR1 may comprise e.g. 1×32, 1×64, 1×128, 1×256, 1×512, 1×1024, 1×2048, . . . detector pixels.

Detector pixels of the detector ARR1 may be arranged as a two-dimensional spatial array in order to measure a first spectrum, which corresponds to a first integration period, and to measure a second spectrum, which corresponds to a second integration period. The number of pixels in the spatial dimension may be e.g. in the range of 1 to 100, and the number of pixels in the spectral dimension may be e.g. in the range of 10 to 10000. The detector ARR1 may comprise e.g. 2×32, 2×64, 2×128, 2×256, 2×512, 2×1024, 2×2048, . . . detector pixels P1. The detector ARR1 may comprise e.g. 4×32, 4×64, 4×128, 4×256, 4×512, 4×1024, 4×2048, . . . detector pixels P1.

When using a SPAD detector ARR1, the detector ARR1 may comprise a set of counters arranged to count pulses provide by the photodiodes. The operation of said set of counters may be enabled and disabled based on the timing signal S_{SYNC}.

The lowermost curve of FIG. 2c shows a temporal response function h(t) of a single photon avalanche diode. The response function h(t) may also be called e.g. as the single photon response of the single photon avalanche diode. The temporal width Δt_{FWHM} of the response function h(t) may be e.g. shorter than or equal to 60 ps. For example, the temporal width Δt_{FWHM} of the response function h(t) may be e.g. in the range of 35 ps to 50 ps. For example, the temporal width Δt_{FWHM} may be substantially equal to 40 ps. The apparatus 500 may comprise a delay unit for controlling a time delay Δτ₀. The time delay Δτ₀ may denote e.g. a difference between the time t₀ₐ of the rising edge of the temporal response function h(t) and the time t_{SYNC} of arrival of a timing pulse S_{SYNC} to the detector ARR1.

The temporal response function h(t) may also be interpreted to represent the probability of detecting a photon per unit time. The probability of detecting a photon per unit time may reach a maximum value p_{MAX}. The probability of detecting a photon per unit time may reach 50% of the maximum value p_{MAX} at the times t₀ₐ, t_{0b}. For example, the integrated area of the response function h(t) between the times t₀ₐ, t_{0b} may correspond e.g. to a probability of 10% for detecting a photon, which impinges on a predetermined detector pixel P1 during the time period between the times t₀ₐ, t_{0b}. The temporal width Δt_{FWHM} of the response function h(t) may be determined e.g. by calculating the difference t_{0b}−t₀ₐ. The function h(t) may represent the temporal response function h(t) of a single photon avalanche diode regarding a single detection period. The function h(t) may represent the temporal response function h(t) of a single photon avalanche diode regarding a single detection period. The function h(t) may represent the probability of detecting a photon per unit time when counting photons for a single detection period. The function h(t) may represent the probability of detecting a photon per unit time when counting photons of light LB4 emitted from the sample region REG1 during a time period at a given wavelength λ.

The apparatus 500 may comprise one or more counting units for counting the number of photons detected by a detector pixel P1. The apparatus 500 may comprise one or more counting units for counting the number of photons detected by a second detector pixel P2. In an embodiment, the detector pixels P1, P2 and the counting units may be implemented on the same (semiconductor) substrate. The counting units may be implemented e.g. by means of a computer program running on one or more data processors and/or by means of electronic circuits implemented on a substrate.

The apparatus 500 may comprise a counting unit, which may be arranged to count the number of photons detected by a detector pixel P1 when the sample is illuminated by several light pulses LB3. The counting unit may be arranged to change a counter value each time when a single detector pixel P1 detects a photon during a predetermined (integration) time period. The time period may be precisely timed with respect to the synchronization pulse S_{SYNC}. A counting unit may be arranged to change a counter value each time when the single detector pixel P1 detects a photon during a predetermined time period.

For each illuminating light pulse LB3, the single detector pixel P1 may detect only one photon. The operating parameters of the apparatus 500 may be selected such that the probability of detecting a photon may be e.g. in the range of 0.01% to 10% when the sample region REG1 is illuminated by a single light pulse LB3.

N_{P1} may denote the number of photons detected by a detector pixel P1. N_{LB3} may denote the number of light pulses LB3. The light source LS1 may be arranged to provide N_{LB3} illuminating light pulses LB3 during a time period T_{SEQ}. The length of the time period T_{SEQ} may be e.g. in the range of 1 ms to 1000 s, and the number N_{LB3} may be e.g. in the range of 10² to 10⁶. The intensity of the illuminating light pulses, the duration of the light pulses and the light gathering efficiency of the gathering optics 20 may be selected such that the ratio N_{P1}/N_{LB3} may be e.g. in the range of 0.01% to 10%.

If the ratio N_{P1}/N_{LB3} is too low, the total time needed to measure the Raman spectrum may be excessively long. If the ratio N_{P1}/N_{LB3} is too high, the measured values b₁, b₂, b₃ are not proportional to the intensity of the scattered light LB4, i.e. the relationship between the intensity of the scattered light LB4 and the measured values b1, b2, b3 become nonlinear. Advantageously, the ratio N_{P1}/N_{LB3} may be e.g. smaller than or equal to 1%.

Referring to FIG. 7b, the detector ARR1 may comprise a pixel P_{0,1} for detecting a photon at a wavelength λ₁ during a first integration time period, a pixel P_{1,1} for detecting a photon at a wavelength λ₁ during a second integration time period, a pixel P_{2,1} for detecting a photon at a wavelength λ₁ during a third time period, and a pixel P_{3,1} for detecting a photon at a wavelength λ₁ during a fourth time period. The detector ARR1 may comprise a counting unit C_{0,1} arranged to provide a measured signal b_{0,1} by counting photons detected by the pixel P_{0,1}. The detector ARR1 may comprise a counting unit C_{1,1} arranged to provide a signal b_{1,1} by counting photons detected by the pixel P_{1,1}. The detector ARR1 may comprise a counting unit C_{2,1} arranged to provide a signal b_{2,1} by counting photons detected by the pixel P_{2,1}. The detector ARR1 may comprise a counting unit C_{3,1} arranged to provide a signal b_{3,1} by counting photons detected by the pixel P_{3,1}.

The detector ARR1 may comprise a pixel P_{0,2} for detecting a photon at a wavelength λ₂ during the first integration time period, a pixel P_{1,2} for detecting a photon at a wavelength λ₂ during the second integration time period, a pixel P_{2,2} for detecting a photon at a wavelength λ₂ during the third integration time period, and a pixel P_{3,2} for detecting a photon at a wavelength λ₂ during a third integration time period. The detector ARR1 may comprise a counting unit C_{0,2} arranged to provide a signal b_{0,2} by counting photons detected by the pixel P_{0,2}. The detector ARR1 may comprise a counting unit C_{1,2} arranged to provide a signal b_{1,2} by counting photons detected by the pixel P_{1,2}. The detector ARR1 may comprise a counting unit C_{2,2} arranged to provide a signal b_{2,2} by counting photons detected by the pixel P_{2,2}. The detector ARR1 may comprise a counting unit C_{3,2} arranged to provide a signal b_{3,2} by counting photons detected by the pixel P_{3,2}.

The detector ARR1 may comprise pixels P and counters C for providing measured signals b in a corresponding way at further wavelengths λ₃, λ₄, λ₅, λ₆, . . . λₖ, λₖ₊₁, . . . λ_{N}. The detector ARR1 may comprise pixels P and counters C e.g. for measuring the spectral intensity at the different wavelength bands having the central wavelengths λ₁, λ₂, . . . λₖ, λₖ₊₁, . . . λ_{N}. The detector ARR1 may comprise pixels P for measuring the spectral intensity e.g. at 1024 adjacent wavelength bands.

The timing of the first, second, third and fourth integration time periods with respect to the synchronization pulse S_{SYNC} may be controlled e.g. by delays Δτ₀, Δτ₁, Δτ₂, Δτ₃. The detector ARR1 or the apparatus 500 may comprise delay units for providing the delays Δτ₀, Δτ₁, Δτ₂, Δτ₃.

In an embodiment, the signals b_{0,1}, b_{1,1}, b_{2,1}, b_{3,1} may also be provided by using a single photon avalanche diode (e.g. P_{0,1}). In an embodiment, the signals b_{0,1}, b_{1,1}, b_{2,1}, b_{3,1} may also be provided by using a single photon avalanche diode (e.g. P_{0,1}) and by using the counting units C_{0,1}, C_{1,1}, C_{2,1}, C_{3,1}. For example, the counting unit C_{0,1} may be arranged to provide a signal value b_{0,1} by counting photons detected by the single photon avalanche diode P_{0,1} during the first integration time period, the counting unit C_{1,1} may be arranged to provide a signal value b_{1,1} by counting photons detected by the single photon avalanche diode P_{0,1} during the second integration time period, the counting unit C_{2,1} may be arranged to provide a signal value b_{2,1} by counting photons detected by the single photon avalanche diode P_{0,1} during the third integration time period, and the counting unit C_{3,1} may be arranged to provide a signal value b_{3,1} by counting photons detected by the single photon avalanche diode P_{0,1} during the third integration time period. For example, the detector ARR1 or the control unit CNT1 may comprise a memory MEM1 for storing values of the signals b_{0,1}, b_{1,1}, b_{2,1}, b_{3,1}.

The signals b_{0,2}, b_{1,2}, b_{2,2}, b_{3,2} may also be provided by using the single photon avalanche diode (e.g. P_{0,2}). The signals b_{0,3}, b_{1,3}, b_{2,3}, b_{3,3} may also be provided by using the single photon avalanche diode (e.g. P_{0,3}). The signals b_{0,4}, b_{1,4}, b_{2,4}, b_{3,4} may also be provided by using the single photon avalanche diode (e.g. P_{0,4}). The signals b_{0,5}, b_{1,5}, b_{2,5}, b_{3,5} may also be provided by using the single photon avalanche diode (e.g. P_{0,5}). The signals b_{0,6}, b_{1,6}, b_{2,6}, b_{3,6} may also be provided by using the single photon avalanche diode (e.g. P_{0,6}).

The detector ARR1 may be arranged to operate such that the counters C may be enabled and disabled based on the synchronization signal S_{SYNC}. The integration of the optical signal with the detector array ARR1 may be enabled and disabled with a short time response resulting in no penalty from detector read noise which may be the case when using e.g. a conventional CCD detector. Using the detector array ARR1 may thus allow splitting a total measurement time period into a plurality of integration times. Measured data obtained during said (different) integration times may be sorted into separate groups (e.g. in different memory areas). For example, a first intensity value representing a first integration time may be stored in a first memory area, and a second intensity value representing a second subsequent integration time may be stored in a second memory area.

The detector array ARR1 may comprise an array of CMOS single photon avalanche diodes (CMOS SPAD). The CMOS SPAD may provide fast response and a spectral sensitivity, which may match with the wavelength of the illuminating pulses LB3 provided by the converter unit 100. The combination of the converter unit 100 and the CMOS SPAD may be suitable of time-gated measurement of Raman spectrum of the sample MX. When used for measuring Raman scattering, the operation of the SPAD detector may be time-gated so as to reduce signal noise and/or so as to reduce the effect of fluorescence.

The apparatus 500 may be used e.g. for performing Surface Enhanced Raman Spectroscopy. The sample MX may comprise e.g. gold particles. The wavelength of the illuminating light pulses LB3 may be suitable for exciting a Raman spectrum from a sample MX, which comprises gold particles. The wavelength of the illuminating light pulses LB3 may be in a spectral region where the nanometer-sized gold particles have a high spectral reflectance. The wavelength of the illuminating light pulses LB3 may be e.g. in the range of 600 nm to 700 nm. In particular, the wavelength of the illuminating light pulses LB3 may be e.g. 620 nm or 676 nm.

The use of single photon avalanche diodes (SPAD) may provide short response, high sensitivity, and accurate control of time gating.

The detector array ARR1 may comprise one or more other detectors instead of the single photon avalanche diodes, or in addition to single photon avalanche diodes.

The detector array ARR1 may comprise e.g. an intensified charge-coupled device (ICCD). CCD means a charge-coupled device. The intensified charge-coupled device may comprise an image intensifier coupled to a CCD device. The intensifier may comprise a photocathode, a micro-channel plate (MCP) and a phosphor screen. When used for measuring Raman scattering, the operation of the intensified charge-coupled device may be time-gated so as to reduce signal noise and/or so as to reduce the effect of fluorescence.

The Raman spectrum may be measured e.g. by using an electron multiplying charge coupled device (EMCCD). The EMCCD detector may also be enabled and disabled based on timing of the illuminating light pulses, so as to reduce signal noise and/or so as to reduce the effect of fluorescence.

The detector array ARR1 may comprise an array of photomultiplier tubes. The detector array ARR1 may comprise e.g. two or more photomultiplier tubes. The photomultiplier tubes may be arranged to detect single photons. The detector ARR1 comprising photomultiplier tubes may be arranged to measure spectral intensities in a time gated manner. The detector ARR1 may be arranged to measure spectral intensities by time gated detection. The apparatus may be arranged to count detected photons by using one or more time-gated counters.

Spectral data measured by the apparatus 500 may be used e.g. for controlling operation of a system. For example, a chemical process or a cell culture process may be controlled based on a Raman spectrum measured by the apparatus 500.

The apparatus 500 may be arranged to provide a fluorescence spectrum of the sample MX, in addition to providing the Raman spectrum. The apparatus 500 may be arranged to provide a fluorescence spectrum of the sample MX, instead of providing the Raman spectrum.

A spectral position may be defined by specifying a wavelength. The term “wavelength” may refer to a spectral position.

For the person skilled in the art, it will be clear that modifications and variations of the devices and the methods according to the present dislcosure are perceivable. The figures are schematic. The particular embodiments described above with reference to the accompanying drawings are illustrative only and not meant to limit the scope of the present disclosure, which is defined by the appended claims.

1. An apparatus, comprising:
a laser unit to form laser pulses,
a conversion unit to form illuminating pulses from optical energy of the laser pulses,
optics to gather scattered light from a sample when the sample is illuminated with the illuminating pulses,
a spectral disperser to spatially separate spectral components of the scattered light,
a detector array to measure intensity of the separated spectral components,
wherein the conversion unit comprises:
a first crystal to generate light pulses by sum frequency generation, and
a second resonator crystal to generate light pulses by stimulated Raman scattering.

2. The apparatus of claim 1, wherein the first crystal is arranged to generate second light pulses from the optical energy of the laser pulses by second harmonic generation, and the second resonator crystal is arranged to generate the illuminating pulses from the second light pulses by stimulated Raman scattering.

3. The apparatus of claim 1, wherein the second resonator crystal is arranged to generate second light pulses from the optical energy of the laser pulses by stimulated Raman scattering, and the first crystal is arranged to generate the illuminating pulses from the second light pulses by second harmonic generation.

4. The apparatus of claim 1 wherein the wavelength of the laser pulses is 1064 nm.

5. The apparatus (500) of claim 1 wherein the laser unit comprises a microchip laser, which is arranged to generate laser light pulses at the wavelength of 1064 nm.

6. The apparatus of claim 1 wherein the wavelength of the formed illuminating pulses is in the range of 0.53 to 0.64 times the wavelength of the laser pulses.

7. The apparatus of claim 1 wherein the laser unit comprises a microchip laser, the laser unit is arranged to generate laser light pulses at the wavelength of 1064 nm, and wherein the temporal width of the laser light pulses is longer than or equal to 50 ps.

8. The apparatus of claim 1 wherein the temporal width of the illuminating pulses is in the range of 25% to 60% of the temporal width Δ_{tFWHM,LB1} of the laser pulses.

9. The apparatus of claim 1 wherein the conversion unit is arranged to provide the illuminating pulses at the wavelength of a second Stokes component of the stimulated Raman scattering.

10. The apparatus of claim 1 wherein the second crystal is selected from a group consisting of a diamond crystal, a potassium gadolinium tungstate crystal, and a barium nitrate crystal.

11. The apparatus of claim 1 wherein the apparatus is arranged to:
measure a first value indicative of a total intensity at a first time,
measure a second value indicative of fluorescence intensity at a second time,
estimate fluorescence intensity at the first time based on at least the measured second value, and
determine a Raman signal value from the first value and from the second value by using the estimated fluorescence intensity.

12. A method, comprising:
providing laser pulses,
forming illuminating light pulses from optical energy of the laser pulses by using a conversion unit,
illuminating a sample with the illuminating light pulses,
collecting scattered light from the sample when the sample is illuminated with the illuminating pulses,
spatially separating spectral components of the scattered light,
measuring the intensity of the separated spectral components by using a detector array,
wherein the conversion unit comprises:
a first crystal to generate light pulses by sum frequency generation, and
a second resonator crystal to generate light pulses by stimulated Raman scattering.

13. The method of claim 12, wherein the first crystal is arranged to generate second light pulses from the optical energy of the laser pulses by second harmonic generation, and the second resonator crystal is arranged to generate the illuminating pulses from the second light pulses by stimulated Raman scattering.

14. The method of claim 12, wherein the second resonator crystal is arranged to generate second light pulses from the optical energy of the laser pulses by stimulated Raman scattering, and the first crystal is arranged to generate the illuminating pulses from the second light pulses by second harmonic generation.

15. The method of claim 12, wherein the laser light pulses are generated by using a microchip laser such that the wavelength of the laser light pulses is 1064 nm.
